(19) United States
(12) Patent Application Publication
(10) Pub. No.: US 2026/0270095 A1
(43) Pub. Date: Sep. 10, 2026

(54) DEVICE COMMUNICATION AND SECURITY SHELL

(71) Applicant: Focus on Cyberdesigns LLC, Falcon Heights, MN (US)

(72) Inventor: Gregory Machler, Falcon Heights, MN (US)

(21) Appl. No.: 19/555,076

(22) Filed: Mar. 3, 2026

Related U.S. Application Data
(60) Provisional application No. 63/766,610, filed on Mar. 4, 2025.

(51) Int. Cl. H04L 9/32; H04W 12/08

(52) U.S. Cl. CPC H04L 9/3268; H04L 9/3234; H04W 12/08

(57) ABSTRACT

An Internet of Things (IoT) shell (called a Cover Shell) provides data communication protocols and security components needed for IoT devices for operation of the applications and the network stacks they use. The shell provides multiple communication protocol layers including a device driver, an IP (Internet Protocol) layer, TCP and UDP (transmission control protocol/user datagram protocol) layer, and session layer. It also provides security functions such as including anomaly, return to safe state, reboot, and rollback functions that can be shared by multiple types of IoT products.

### RELATED APPLICATION

This application claims priority to U.S. Provisional Application Ser. No. 63/766,610 (entitled Device Communication and Security Shell, filed Mar. 4, 2025) which is incorporated herein by reference.

### BACKGROUND

Developers of Internet of Things (IoT) devices need to design the devices to communicate with product management applications via communication protocol stacks. These protocol stacks and security can be shared by multiple different applications. The original application and security shell can be integrated together. The original application then executes within the security shell. There are many different protocols and components and it is difficult and time consuming to keep them current and properly tested for many different applications. The deployment of these protocols may be scattered randomly throughout different applications.

The security shell provides common service functions including authentication, authorization, encryption, device management, and remote provisioning through standardized RESTful APIs. The lack of using a shell architecture can lead to a substantial integration effort to map its generic common service functions to the specific security requirements of IoT devices, such as those in manufacturing and medical device networks.

### SUMMARY

An Internet of Things technology (IoT) shell (called a Cover Shell) provides data communication protocols and security components needed for IoT devices for operation of the applications and the network stacks they use. The shell provides multiple communication protocol layers including a device driver, an IP (Internet Protocol) layer, TCP and UDP (transmission control protocol/user datagram protocol) layer, and a session layer.

The shell also provides security components including a authentication and authorization module, bridge module, DoS (denial of service) module, error module, network module, file manager module, over the air update module, secure boot loader module, a session manager module, and a systems/hardware module. The Cover shell runs above the TCP/IP (transmission control protocol/internet protocol) layers and therefore can support multiple sessions. The sessions share the same shell and application.

The Cover shell, covers or protects Core applications by acting as a security blanket for them. Any Cover shell that operates above the Transport layer can be protected by a Cover shell.

One of the advantages of the Cover shell architecture is that it makes coding of embedded security software more consistent and easier to update. Core applications that use the Cover shell are more dependable and consistent because they use the same architecture. All Cover shell functions can be localized to modules that support multiple applications.

The shell is an architecture, not software so it can be shared amongst multiple Core applications. This allows for quicker code updates, builds, integrations, and deployments of the Cover shell and the Core application because much of the security functions are isolated within Cover shell. This is a great help in addressing global hacking.

### BRIEF DESCRIPTION OF THE DRAWINGS

FIG. 1 illustrates the whole Cover IoT Shell architecture containing the entire network and security modules that are part of the shell. Those modules are broken down by Module in the following FIGS. 2-11.

FIG. 2 illustrates an Authentication and Authorization Module architecture according to an example embodiment.

FIG. 3 illustrates a Bridge Module architecture according to an example embodiment. Its use within the shell is optional.

FIG. 4 illustrates a Denial of Service Module architecture according to an example embodiment.

FIG. 5 illustrates an Error Module architecture according to an example embodiment.

FIG. 6 illustrates a File Manager Module architecture according to an example embodiment.

FIG. 7 illustrates a Network Module architecture according to an example embodiment.

FIG. 8 illustrates an Over the Air Update Module architecture according to an example embodiment.

FIG. 9 illustrates a Secure Boot Module architecture according to an example embodiment.

FIG. 10 illustrates a Session Manager Module architecture according to an example embodiment.

FIG. 11 illustrates a Systems/Hardware Module architecture according to an example embodiment.

FIG. 12 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention. It is to be understood that other embodiments may be utilized and that logical changes may be made without departing from the scope of the present invention. The following description of example embodiments is, therefore, not to be taken in a limited sense, and the scope of the present invention is defined by the appended claims.

The integration of connected IoT (Internet of Things) devices into vertical markets such as medical devices and manufacturing environments. IoT products now run on internet protocols like TCP/IP and https which can be addressed globally over the internet.

Nefarious entities are creating new applications to breach devices every day. This potentially could lead to the harm of death of people that use or rely on the safety of those devices.

A lack of proper cybersecurity architecture could lead to: medical device breach, patient death or injury and manufacturing line breach, critical manufacturing line failure or ransomware theft.

Simple devices like lighting, doors, cameras, and other devices can be converted into bots which can attack critical medical devices, oil and gas refineries, manufacturing lines, etc., while obscuring where the attacks are coming from.

Without a common architecture, implementation remains cumbersome for IoT device developers. The shell architecture avoids a substantial integration effort to map its generic common service functions to the specific security requirements of IoT devices which operate in industrial environments such as manufacturing plants, and medical device networks. The Error Modules return to safe state executes when there is a security failure. There may be software that is not within the shell architecture. These gaps require IoT developers to build custom security logic which negates some of the abstraction benefit and the scattering of security-related code throughout applications.

An improved cybersecurity shell architecture, referred to as a Cover Shell, protects Internet of Things (IoT) devices from cyber threats. The architecture provides a secure-by-design approach that separates cybersecurity functions from core device application functions, thereby facilitating effective and efficient security updates while minimizing risk to interference with the underlying device operation and relieving designers of such core device shell functions from the need to become experts in cyber security.

The Cover Shell separates cybersecurity functions from core device application functions by organizing security operations into discrete modules, each comprising one or more sets of security functions, that execute according to predefined execution flows. The Cover Shell wraps around a Core Application—the software that performs the device-specific functions of the IoT device—and manages network communication, authentication, session establishment, file and certificate handling, denial of service detection, error handling, and system integrity monitoring on behalf of the Core Application.

The Core Application executes after the Cover Shell authenticates an incoming session. An application image comprising the compiled integration of both the Cover Shell and the Core Application is loaded into device memory by a boot loader or an over the air update. Because the Cover Shell is an architecture rather than application-specific software, the same Cover Shell module and set structure can be shared across multiple Core Applications of different device types—such as medical devices, manufacturing controllers, and building automation systems—while the integration between the Cover Shell and each Core Application may differ. This separation allows security functions to be updated within the Cover Shell modules and sets without requiring modification to the Core Application, and confines changes to identified locations within the module hierarchy rather than scattering security-related code throughout the device software.

Prior approaches to IoT device security have required developers to implement security logic within or alongside the device application itself, resulting in security code dispersed across the application, inconsistent security behavior across device types, and time-consuming integration and update cycles when new threats emerge. The Cover Shell architecture addresses these problems by localizing security functions within a defined modular structure with predefined execution flows between modules, enabling developers to identify where new security functionality should be deployed, to update security modules without altering the Core Application, and to apply the same security architecture across different IoT products within an organization.

The improved cybersecurity shell architecture provides a modular security architecture with predefined execution flows tailored for IoT devices. Unlike generic common functions requiring substantial custom integration, the cybersecurity shell defines discrete security modules, including Authentication and Authorization, Bridge, Denial of Service, Error, File Manager, Network, Over the Air Update, Secure Bootloader, Session Manager, and System/Hardware Modules.

The Cover Shell architecture has a hierarchy: Modules-Sets-Functions. The Modules and the Sets make up the architecture of the Cover shell. The Modules are made up of Sets and the Sets are made up of Functions. The Functions are the software and are not part of the Cover Shell architecture. The Cover shell software integrates with the Core application. The Core application is the software that performs the main IoT functions like controlling the lights in your home from somewhere on the internet.

This predefined flow architecture eliminates the ad hoc security interactions that complicate implementations and enables security module updates without modification to the Core application. The modular architecture localizes current and future cybersecurity changes within specific Modules and Sets, enabling developers to identify precisely where new cybersecurity functionality should be deployed for future product enhancements. This localization reduces product risk when new cybersecurity software is added or removed because changes are confined to specific Modules and Sets rather than scattered throughout the application. The architecture also provides consistency across multiple device types within an organization, enabling software engineers to apply the same security architecture to different IoT products and thereby update security functionality efficiently across product lines.

The cybersecurity shell further addresses IoT-specific requirements related to different software and hardware for multiple devices. The Return to Safe State Set will likely be different for different versions of hardware and software. The Return to Safe State Set, Reboot Set, and Rollback Set within the Error Module returns the Core Application to a safe operating state upon detection of a Cover shell or Core application error. The architecture aligns with the IEC 62443 security framework and STRIDE threat framework. The Error Module receives execution flows from all other security modules based upon detection of error conditions found in the software or hardware, ensuring consistent error handling and logging across the cybersecurity shell.

The Return to Safe State Set, Reboot Set, and Rollback Set implement device-specific logic that places the IoT device in a non-hazardous state. Security failures prevent normal operation, addressing safety requirements for IoT devices in industrial environments where security failures could otherwise result in physical harm. By providing this structured IoT shell architecture, the cybersecurity shell reduces integration effort for device developers while delivering consistent security behavior across different IoT device types and enabling rapid deployment of security updates in response to emerging threats.

The Cover shell architecture is described in that it illustrates the primary functional components of the cybersecurity shell, including communication protocol layers, security modules, and the relationship between the shell and Core applications.

### Applicable Cybersecurity Frameworks

The IEC 62443 and STRIDE cybersecurity framework define requirements for industrial and medical devices, and other vertical markets that are applicable to IoT devices.

The improved cybersecurity architecture simplifies lifecycle management by allowing simplified updates to security components. Table 1 shows the mapping of CEC 62443 framework to the embedded device modules.

TABLE 1
IEC 62443 Framework

| IEC 62443 | | Embedded | |
|---|---|---|---|
| Requirement | Reference | Device Feature | Description |
| Identification | IEC 62443- | Secure Boot, | Verifies firmware integrity and |
| and | 1-2, CR 1.1 | Access Control | enforces user authentication (3). |
| Authentication | | | |
| Controls (IAC) | | | |
| Use Control | IEC 62443- | Trusted | Restricts device functions to |
| (UC) | 4-2, CR 2.1 | Execution | authorized uses via isolated |
| | | Environment, | execution (3). |
| | | Access Control | |
| Data Integrity | IEC 62443- | Cryptographic | Ensures data integrity using AES- |
| (DI) | 4-2, CR 3.1 | Accelerator | 256 encryption and secure |
| | | | software modules (3) |
| Data | IEC 62443- | Tamper- | Protect sensitive data with secure |
| Confidentiality | 4-2, CR 4.1 | Resistant | storage and encryption. |
| (DC) | | Memory | |
| Timely | IEC 62443- | Intrusion | Detects and logs security events |
| Response | 4-2, CR 7.1 | Detection | in real-time using hardware and |
| to Events | | System, HSM | software monitoring. |

Table 1 describes some IEC 62443 features that address the cybersecurity of IoT (Internet of Things) devices.

The cybersecurity shell may incorporate hardware security features to support the IEC 62443 requirements described in Tables 1 and 2. A Trusted Execution Environment (TEE) provides an isolated execution environment within the processor that protects sensitive security operations from unauthorized access by the Core Application or external attackers. The TEE executes security-critical functions such as cryptographic key management, certificate validation, and authentication credential processing in isolation from the main operating environment. A Cryptographic Accelerator performs high-speed encryption and decrypt ion operations using algorithms such as AES-256 for symmetric encryption and RSA for asymmetric encryption, offloading computationally intensive cryptographic operations from the main processor to improve performance while maintaining security. Tamper-Resistant Memory stores cryptographic keys, certificates, and other sensitive data in a protected memory region that prevents unauthorized access or extraction, even when physical access to the device is obtained. The File Manager Module files with sensitive data such as certificates in a Trusted Platform Module (TPM) or Hardware Security Module (HSM) or as a separate secure memory component. System/Hardware Module intrusion detection logic monitors system behavior in real-time, comparing observed behavior against known attack signatures and baseline normal behavior to detect anomalies indicative of security threats. The Systems/Hardware intrusion detection logic logs detected anomalies to the Error Module and may trigger protective responses including session termination, traffic blocking, or return to safe state.

TABLE 2
Mapping of IEC 62443 Requirements to Cybersecurity Features

| Type | Feature | Purpose |
|---|---|---|
| Hardware | Secure | Ensures only trusted firmware is executed by |
| | Bootloader | verifying digital signatures during startup. |
| Hardware | Trusted | Provides and isolates environment for sensitive |
| | Execution | operations, protecting against unauthorized access. |
| | Environment | |
| | (TEE) | |
| Hardware | Cryptographic | Performs high-speed encryption/decryption (e.g., |
| | Accelerator | AES-256, RSA) to secure data. |
| Hardware | Tamper-Resistant | Stores cryptographic keys and sensitive data to |
| | Memory | prevent unauthorized access or extraction. |
| Hardware | Hardware | Manages cryptographic operations and key lifecycle |
| | Security Module | securely. |
| | (HSM) | |
| Software | Secure | Validates firmware updates to prevent installation of |
| | Bootloader | malicious code. |
| Software | Access Control | Enforces role-based access to device functions and |
| | Module | data. |
| Software | Authentication | Performs authentication of device and users |
| Software | Intrusion | Monitors system behavior and logs anomalies for |
| | Detection System | real-time threat detection. |
| Software | Update Manager | Manages secure, incremental updates to the |
| | | cybersecurity shell while making minimal changes |
| | | to the Core application. |

A Trusted Platform Module (TPM) is a dedicated hardware component, typically implemented as a discrete chip or as firmware integrated into a processor, that manages cryptographic keys and performs cryptographic operations within a tamper-resistant physical boundary. A TPM contains a cryptographic processor that generates, stores, and manages cryptographic keys such that key material is not exposed to software running outside the TPM boundary. The TPM performs cryptographic operations including key generation, encryption, decryption, hashing, and digital signing within this boundary. The TPM maintains a set of Platform Configuration Registers (PCRs) that store hash measurements of software and firmware loaded during the boot process, enabling the Secure Bootloader Module to verify that the device firmware has not been altered. The TPM also provides sealed storage, which binds data to a specific device configuration as recorded in the PCRs, so that stored data such as certificates and configuration files managed by the File Manager Module can only be decrypted when the device is in a known and verified state. In the Cover Shell architecture, the TPM stores certificates used by the Secure Bootloader Module and the Over the Air Update Module to authenticate downloaded software, session encryption data used by the Session Manager Module, configuration data used by the File Manager Module, denial of service signature data used by the Denial of Service Module, error logs maintained by the Error Module, and bridge configuration data used by the Bridge Module.

A Hardware Security Module (HSM) is a dedicated hardware device that also manages cryptographic keys and performs cryptographic operations within a tamper-resistant physical enclosure. An HSM may be implemented as an external network-attached device, as a PCIe card installed in a server, or as an embedded component within an IoT device's System on Chip (SoC). Like a TPM, an HSM generates and stores cryptographic keys within its hardware boundary and performs encryption, decryption, and digital signing operations without exposing key material to external software. An HSM differs from a TPM in that an HSM is typically designed to manage a larger number of cryptographic keys, to support higher-throughput cryptographic operations, to serve multiple devices or applications, and to provide additional physical tamper protections including tamper-evident seals, active tamper response mechanisms that erase key material upon detection of physical intrusion, and environmental sensors that detect out-of-range temperature or voltage conditions. Within the Cover Shell architecture, the TPM and HSM are referenced interchangeably as the hardware storage location for certificates, configuration data, encryption keys, and other data used by the Cover Shell modules and the Core Application. A given IoT device implementation may use a TPM, an HSM, or both, depending on the security requirements and hardware capabilities of the device. References to “TPM or HSM” throughout this specification indicate that either hardware component, or a combination thereof, may be used to provide the described hardware-based key management, cryptographic operations, and tamper-resistant storage functions.

### STRIDE Framework

Another cybersecurity framework for software is STRIDE. It stands for Spoofing, Tampering, Repudiation, Information Disclosure, Denial of Service, and Elevation of Privilege.

Table 3 shows the overlap between IEC 62443 and STRIDE. Both frameworks will be used to form a cybersecurity architecture for devices that have SoC chipsets within them.

TABLE 3
STRIDE requirements versus IEC 62443 requirements

| IEC 62443 | STRIDE | Analysis |
|---|---|---|
| Identification | Spoofing | Spoofing: Involves illegally accessing and then using |
| and | Elevation of | another user's authentication information, such as |
| Authentication | Privilege | username and password. |
| Controls (IAC) | | Elevation of Privilege: An unprivileged user gains |
| | | privileged access and thereby has sufficient access to |
| | | compromise or destroy the entire system. Elevation of |
| | | privilege threats include those situations in which an |
| | | attacker has effectively penetrated all system defenses |
| | | and become part of the trusted system itself, a |
| | | dangerous situation indeed |
| Tamper | Tampering | Tampering: Involves the malicious modification of |
| Resistant | | data. Examples include unauthorized changes made to |
| Memory | | persistent data, such as that held in a database, and |
| | | the alteration of data as it flows between two |
| | | computers over an open network, such as the Internet |
| | | Handled with Error Module that has logging |
| Authorization | Repudiation | Associated with users who deny performing an action |
| | | without other parties having any way to prove |
| | | otherwise—for example, a user performs an illegal |
| | | operation in a system that lacks the ability to trace the |
| | | prohibited operations. Non-Repudiation refers to the |
| | | ability of a system to counter repudiation threats. For |
| | | example, a user who purchases an item might have to |
| | | sign for the item upon receipt. The vendor can then |
| | | use the signed receipt as evidence that the user did |
| | | receive the package |
| | | File Manager uses certificates to address repudiation. |
| | | This is what is used in this architecture. |
| | | Logging of actions can also be used to address non- |
| | | repudiation. |
| Access Control | Information | Involves the exposure of information to individuals |
| | Disclosure | who are not supposed to have access to it—for |
| | | example, the ability of users to read a file that they |
| | | were not granted access to, or the ability of an |
| | | intruder to read data in transit between two computers |
| Denial of | Denial of | Denial of service (DoS) attacks deny service to valid |
| Service | Service | users, for example, by making a Web server |
| | | temporarily unavailable or unusable. You must |
| | | protect against certain types of DoS threats simply to |
| | | improve system availability and reliability |

The cybersecurity shell addresses the STRIDE framework. The Cover shell includes control functions that restrict file access and data access to authorized users based upon role-based access control policies, encryption functions that protect data at rest and data in transit from unauthorized reading, and data sessions to the Core application and the internet application thereby detecting and prevents unauthorized data exfiltration. The Information Disclosure Prevention Set (synonymous with the Authorization Set) which enforces data access policies found within the TPM or HSM. They are used by the File Manager Module to ensure that sensitive files including certificates, configuration data, and cryptographic keys are accessible only to authorized security devices and users. When the Authentication Set detects an unauthorized access attempt, execution is routed to the Error Module for logging and the access attempt is denied.

### Definition of Cybersecurity Architecture

The modular cybersecurity architecture organizes security functions in a three-level hierarchy comprising Modules, Sets, and Functions. At the highest level, modules represent discrete security domains that address specific categories of security requirements, such as authentication, denial of service detection, or error handling. Each Module comprises one or more Sets, where each Set represents a group of related security functions that operate together to address a specific security concern within the module's domain. For example, the Authentication and Authorization Module comprise an Authentication Set, an Authorization Set, a Spoofing Set, an Elevation of Privilege Set, and a Non-Repudiation Set. At the lowest level, functions represent the actual executable code that implements the security logic within each Set. The functions within each Set are designed to interact with the minimum portion of the Core Application necessary to perform their security function, thereby localizing security-related code and minimizing the coupling between the cybersecurity shell and the Core Application. This hierarchical organization enables developers to update individual functions within a Set, replace entire Sets within a Module, or add new Modules to the cybersecurity shell without requiring modifications to the Core Application or to unrelated security Modules. The localized nature of changes within the hierarchy reduces the risk of introducing new vulnerabilities when updating security functionality and simplifies testing and validation of security updates.

A modular cybersecurity architecture is the detailed Module and Set definitions and execution flows between them. These Modules and Sets map to industry cybersecurity frameworks including IEC 62443 and STRIDE. A shell architecture may be implemented across a variety of IoT device platforms to provide updateable security functions with minimal change to existing and new core applications.

A Cover shell security function may review security triggers via anomaly logic to determine if the IoT application has been compromised. A compromised environment may lead to a rollback or reboot of the embedded application to remove the improper device state and put the application in a safe state. Other system/hardware functions may also bring the Core Application back to a safe state.

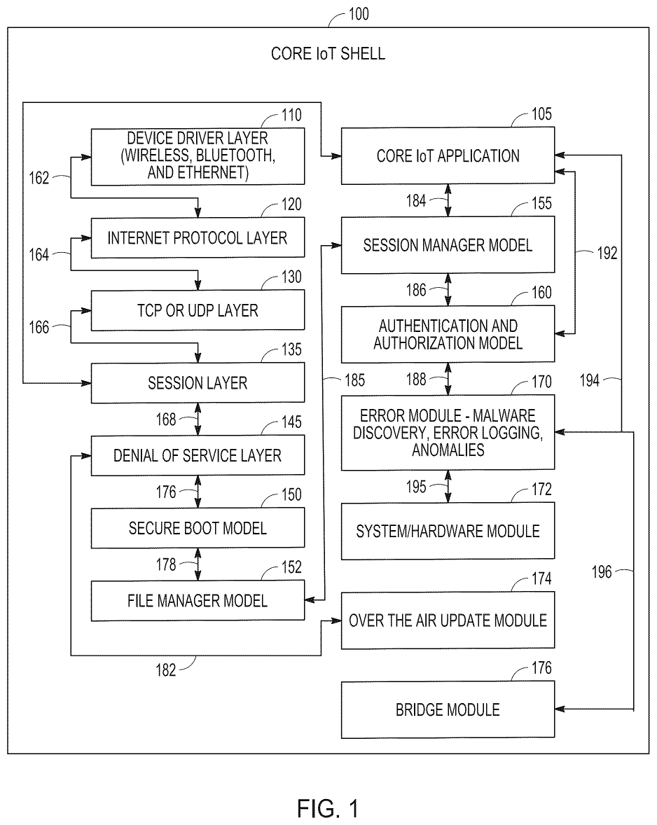

FIG. 1 is a block flow diagram of a Core application 100 and a Cover shell 105. The device driver uses one of the 802.11 wireless standards, Bluetooth, or some other device driver protocol.

The device driver can be a wireless driver or a Bluetooth driver. A device driver layer 110 sends (Flow 162) traffic to the Internet Protocol Layer 120. The Internet Protocol Layer 120 sends (Flow 164) traffic to the Transport Layer 125.

The TCP or UDP layer forwards (Flow 166) to the Session Layer 135. The Session Layer 135 routes (Flow 168) to the Denial of Service Module 145 to determine is the shell or application is being flooded with network traffic. If the Denial of Service Module 145 is in startup mode (Flow 176) routes traffic to the Secure Boot Module 150. The Secure Boot Module 150 only communicates (Flow 178) with the File Manager 152 to collect certification and configuration data. The File Manager 152 determines if the downloaded software has been corrupted and therefore it cannot be deployed.

Critical Cover shell and Core Application 105 data is stored in the TPM or HSM.

The Over the Air Update Module 174 acts in a similar manner as the Secure Boot Module 150. It enables an update of configuration data within the Cover shell and Core application.

The File Manager 152 handles sensitive configuration data that the Cover and its Core application 105 use. It accesses the Session Layer 135 via (Flows 168, 176, and 178, 184, 185) thru to the Session Manager Module 155. The Session Manager Module 155 forwards (Flow 184) to the Core Application 105 when a session with the Core Application 105 has already been established. The Session Manager Module also forwards (Flow 186) traffic to the Authentication and Authorization Module 160 to make sure the sessions are properly authenticated and the authorization standards are correct.

The Authentication and Authorization Module 160 determines whether sessions should be forwarded (Flow 192) to the Core Application 105 or if it stays within the Cover Shell sets for processing.

The Error Module 170 receives errors from all modules within the Cover Shell and the Core Application 105. Within FIG. 1, the Cover Shell shows (Flows 188, 194, 195, and 196) sending error information to the Error Module.

Relevant library APIs within operating systems are not part of this Cover shell. The are libraries that are accessed by functions in each Set within the Cover shell Modules.

The access to the security functions that are part of Sets is determined by the role the administrator has. For example, there could be a local physical security administrator and a remote (over the network) security administrator.

### Error Module

All Modules and Sets within the shell and the Core Application 105 can forward (Flow 194) errors to the Error Module 170.

Security errors will have different priorities indicating whether they are impacting normal Core Application 105 operations or administrative operations

System/Hardware Module 712 sends (Flow 195) system and hardware errors to the Error Module 170. The Error Module also addresses malware discovery, error logging, and finding anomalies.

The Cover shell Network Module is made up of the software and network protocol layers including Network Layers: Device Driver 120, Internet Protocol Layer 125, TCP and UDP Layer 130, and Session Layer Module 135.

Embedded or common operating systems (OS) provide a variety of APIs to facilitate interaction with hardware and software components. These APIs can be categorized based on the level of abstraction they provide, the hardware or peripheral devices they interact with, or the type of functionality they enable.

Multiple Modules are deployed within the Cover shell to serve Core applications. All versions of a given Core application 105 can be kept current with less difficulty because they share the same architecture. This is because changes are managed within the Cover shell where they can be updated in one location. This thereby enables faster recovery from global attacks of their applications.

The following Cover shell Modules and Sets within them have functions that execute within the operating system APIs. The Cover shell and Core Application 105 are using these APIs.

The following Modules exist within the shell: Authentication and Authorization 160, Bridge 176, Denial of Service 145, Error 170, File Manager 152, Network, Over the Air Update 174, Secure Boot 150, Session Manager 155, and Systems/Hardware 172 Modules.

The Cover shell may have multiple applications that it supports. For example: a manufacturing device and medical device could both use the same Cover IoT shell architecture. The Cover IoT shell architecture (modules and sets) could be the same but their integration into the Core application may be different for each Core application.

The Cover shell covers the network protocol layers, and security modules and also the optional Bridge Module 176.

Example: device drivers in the Device Driver Layer 110 include 802.11, Bluetooth, and Ethernet drivers.

If there is any sensitive data within the Cover shell and/or Core applications, it is encrypted at rest with a secure algorithm and retrieved by the File Manager 152. This algorithm can be updated in newer versions of the Cover shell.

### Denial of Service Manager

The Denial of Service Module 145 receives signature data from the TPM or HSM. It examines traffic that comes from the Cover shell and Core applications 105. This protects traffic to/from the Cover shell and Core application 195 from compromise. It may have new DoS signatures that are loaded into it to enable better global protection of DoS attacks.

### Error Module

When the Systems/Hardware Module 172 discovers malware, anomalies, or other module errors they are forwarded (Flow 195) to the Error Module 170. All Cover shell and Core application 105 errors are to be forwarded to the Error Module 170. The Error Module 170 prioritizes errors that are found within the Cover shell or the Core application 105.

### Bridge

The Bridge Module 176 is optional. It enables traffic from the external network to be forwarded to an internal network. Configuration information related to the Bridge is kept in the TPM or HSM.

The administrative role is used to authenticate, provide access controls, and configure Cover shell and Core applications. The access to the security components of the IoT device is determined by which role the administrator has. For example, there could be a local physical security administrator and a remote (over the network) security administrator. These administrative tools that perform administrative functions are outside the scope of this patent.

### Error Manager

The Error Module addresses anomalies, malware, or system/hardware errors. Based upon the type of error it executes the Return to Safe State Set, Reboot Set or Rollback Set. Events will have different priorities indicating whether they are impacting normal Core application operations or administrative operations. Certain error conditions could lead to application rollbacks or reboots.

### File Manager

Critical data is kept in files—algorithms, certificates, configurations—that are used by the Cover shell are kept in the TPM or HSM. The Core application may also have its own critical or configuration data.

### Secure Boot Loader

The Secure Boot Loader 145 protects application images that are being loaded into chipset. It requires TPM or HSM hardware support for the certificates that are needed. Access to the certificates is managed by the File Manager 152.

### APIs for Operating Systems

Embedded and common operating systems provide a variety of APIs to facilitate interaction with hardware and software components. These APIs can be categorized based on the level of abstraction they provide, the hardware or peripheral devices they interact with, or the type of functionality they enable.

All applications sharing the same security shell modules can be kept current because changes are localized within the Cover shell itself, where they can be updated in one location, thereby enabling faster recovery from global attacks of their applications. Core application changes need to be integrated with new shells and compiled together to make a new image to be downloaded or updated within the final application.

### Cover Shell

Operating system APIs include:

TCP/IP Stack APIs: Functions to create and manage TCP and UDP sockets.

Wi-Fi and Bluetooth APIs: For wireless communication and device management. HTTP, MQTT, CoAP: Lightweight protocols commonly used in IoT products. Socket APIs: Functions like socketo, bindo, listeno, accepto, sendo, recvo.

Security APIs within the operating system software are used by functions related to sets in each a Cover shell module. More than one library of security APIs can be used within Cover shell. Some of the APIs may cover authentication and authorization.

Purpose: Allow the embedded systems to use different security APIs to meet secure communication and secure data protection.

Embedded systems, especially those connected to networks, need robust security. Security APIs help implement encryption, authentication, and secure communication. Some APIs include: mbedTLS API-TLS, symmetric and asymmetric encryption, and secure key exchange, encryption, decryption, digital signatures, secure communications and cryptography API (e.g., AES, RSA). Many embedded systems have specific libraries that provide cryptographic operations, including AES (Advanced Encryption Standard), RSA (Rivest-Shamir-Adleman), and HMAC (Hash-based Message Authentication Code).

Error APIs allow embedded systems to use different logging APIs to process Core application events securely.

Several lightweight logging libraries are available that are tailored for embedded systems with a focus on security event logging.

Some APIs include log 4C A lightweight C-based logging framework that provides configurable security event logging. It can be used to log any security-related events or information in a manner that is efficient for embedded environments.

When Anomaly occur, the may be a need to address IoT security needs by downloading new Cover shell and Core application configurations and definitions to find newer anomalies within the embedded applications. The anomaly definitions can be improved without significant changes to the application because the shell addresses the anomalies. Here are set of library APIs that can be used by the functions related to a Set.

Nvidia Jetson is one example of a number of available embedded systems that may be used to find anomaly detection.

IoT DeepStream SDK: A platform for real-time video and sensor data processing, used for detecting anomalies in IoT devices and embedded cameras.

### Use Case:

Anomaly detection in smart cities, industrial robots, or other real-time applications where embedded AI models detect outliers or abnormal events.

Embedded systems increasingly support machine learning for Core applications. Here are Cover shell use cases:

Anomaly detection in smart cities, industrial robots, or other real-time applications.

### Secure Boot APIs

Purpose: Address needs for secure boot of IoT device. This needs hardware support in all IoT products.

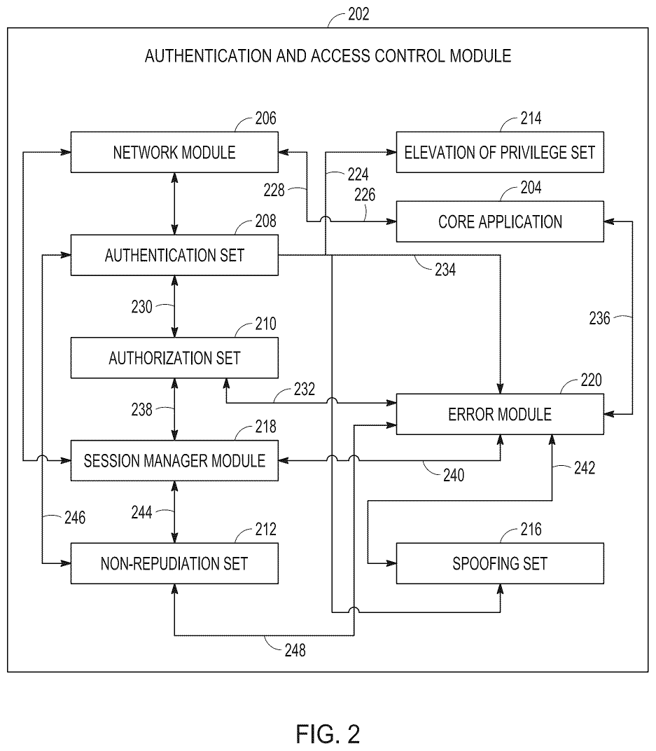

FIG. 2 illustrates a enhanced Authentication and Authorization Module architecture. The architecture is configured to authenticate users and devices and to authorize access to a Core Application 204 after a secure boot is completed. The Authentication and Authorization Module 202 aligns with IEC 62443-3-3 Identification and Authentication Control Functional Requirements 1 and Use Control. Authentication and Authorization Module

The Authentication and Authorization Module 202 comprises a Network Module 206, an Authentication Set 208, an Authorization Set 210, a Non-Repudiation Set 212, an Elevation of Privilege Set 214, a Spoofing Set 216, a Session Manager Module 218, and an Error Module 220. The Network Module 206 is configured to receive incoming network traffic and route the traffic to appropriate components within the Authentication and Authorization Module 202.

The Authentication Set 208 receives packets from a parent application via the Network Module 206 to determine which users can access the Core Application 204. The Authorization Set 210 determines what functions authenticated users and administrators can perform within the Core Application 204. The Non-Repudiation Set 212 verifies that sessions associated with the Session Manager Module 218 cannot be compromised and that user actions can be verified using certificate-based verification. The Elevation of Privilege Set 214 detects unprivileged users attempting to gain privileged access. The Spoofing Set 216 detects unauthorized access attempts using another user's authentication information.

The Session Manager Module 218 establishes and manages sessions between authenticated users or administrators and the Core Application 204. A one-to-one relationship exists between a session and an authenticated user, administrator or a device. The Error Module handles errors that occur in the Core Application 204 or any of the sets within the whole Cover shell.

The Authentication and Authorization Module architecture operates according to the following execution flows. Flow 222 routes traffic from the Network Module 206 to the Authentication and Authorization Module 202 after software is downloaded via a Secure Bootloader Module. Flow 224 executes the Elevation of Privilege Set 214 when the Authentication Set 208 is in an execution flow. Flow 226 bypasses the Authentication Set 208 and routes session traffic directly to the Core Application 204 when authentication has already completed for a given session. Flow 228 forwards initial traffic from the Network Module 206 to the Authentication Set 208. Flow 230 forwards traffic from the Authentication Set 208 to the Authorization Set 210 to determine device or individual access permissions. Flow 232 routes execution to the Error Module 220 when the Authorization Set 210 fails. Flow 234 routes execution to the Error Module 220 when the Authentication Set 208 fails. Flow 236 routes execution from the Core Application 204 to the Error Module 220 when an error occurs in the Core Application 204. Flow 238 executes the Session Manager Module 218 upon successful authorization. Flow 240 routes execution to the Error Module 220 when the Session Manager Module 218 fails. Flow 242 routes execution to the Error Module 220 when the Spoofing Set 216 detects spoofing. Flow 244 executes the Non-Repudiation Set 212 to determine if sessions associated with the Session Manager Module 218 can be compromised. Flow 246 routes execution from the Authentication Set 208 to the Non-Repudiation Set 212 to verify that authenticated users or devices support non-repudiation. Flow 248 routes execution from the Non-Repudiation Set 212 to the Error Module 220 when an error condition occurs. Flow 250 routes execution from the Authentication Set 208 to the Spoofing Set 216 to detect spoofing.

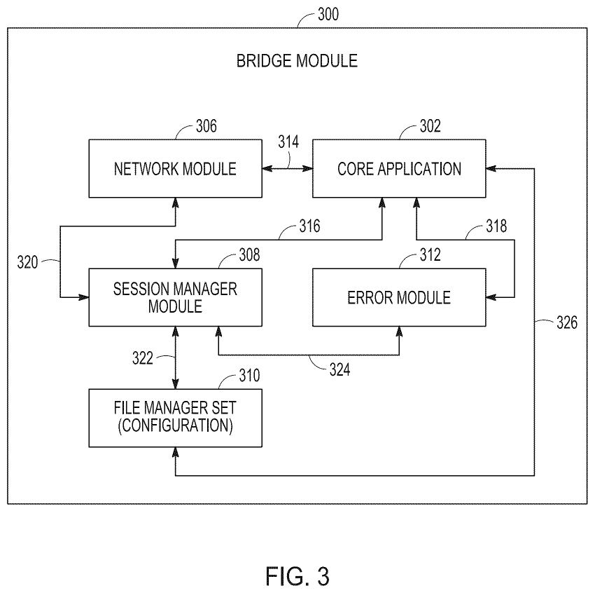

FIG. 3 illustrates a Bridge Module architecture. The Bridge Module architecture addresses communication between a Core Application 302 and an internal network 304 using an internal network protocol distinct from an external network protocol. The Bridge Module architecture is present when application data is manipulated and transmitted to internal application components executed on an internal network 304.

The Bridge Module architecture comprises a Network Module 306, a Session Manager Module 308, a File Manager Set 310, an Error Module 312, and the Core Application 302. The Network Module 306 manages incoming and outgoing packets that communicate with the Core Application 302 using TCP/IP and wireless protocols for external network communication. The Session Manager Module 308 creates sessions that communicate with the Core Application 302, routing execution to the Error Module 312 upon failure and routing traffic to internal network devices upon success. The File Manager Set 310 reads configuration data from a configuration file, wherein the configuration data maps to internal network devices on the internal network 304. The Error Module 312 handles errors from the Session Manager Module 308, the File Manager Set 310, and the Core Application 302.

The Bridge Module architecture comprises an internal network interface configured to communicate with internal network devices using an internal network protocol distinct from the external network protocol used by the Network Module. The internal network interface implements protocol conversion between the TCP/IP-based external network protocol and the internal network protocol, which may comprise Modbus, Modbus TCP, Profibus, Profinet, DeviceNet, CANbus, BACnet, or other fieldbus protocols commonly used in industrial IoT environments. The internal network interface maintains separate communication channels for internal network traffic, isolating internal network communications from external network traffic to prevent external attackers from directly accessing internal network devices. The File Manager Set stores configuration data in the TPM or HSM that maps Core Application data flows to specific internal network devices, including device addresses, protocol parameters, and access permissions. When the Core Application generates data destined for an internal network device, the internal network interface reads the configuration data from the File Manager Set, converts the data to the appropriate internal network protocol format, and transmits the data to the designated internal network device.

The Bridge Module architecture operates according to the following execution flows. Flow 314 routes traffic from the Network Module 30 to the Core Application 302 after sessions have been established. Flow 316 routes application data from the Session Manager Module 308 to the Core Application 302 upon successful session establishment. Flow 318 routes execution from the Core Application 302 to the Error Module 312 when an error occurs. Flow 320 forwards traffic from the Network Module 306 to the Session Manager Module 308 when the traffic is not yet operating in a session. Flow 322 routes execution from the Session Manager Module 308 to the File Manager Set 310 upon successful session establishment, wherein the File Manager Set 310 reads the configuration file for Bridge routing of traffic on the internal network 304. Flow 324 routes execution from the Session Manager Module 308 to the Error Module 312 upon session establishment failure. Flow 326 routes execution from the File Manager Set 310 to the Core Application 302 upon successful file reading.

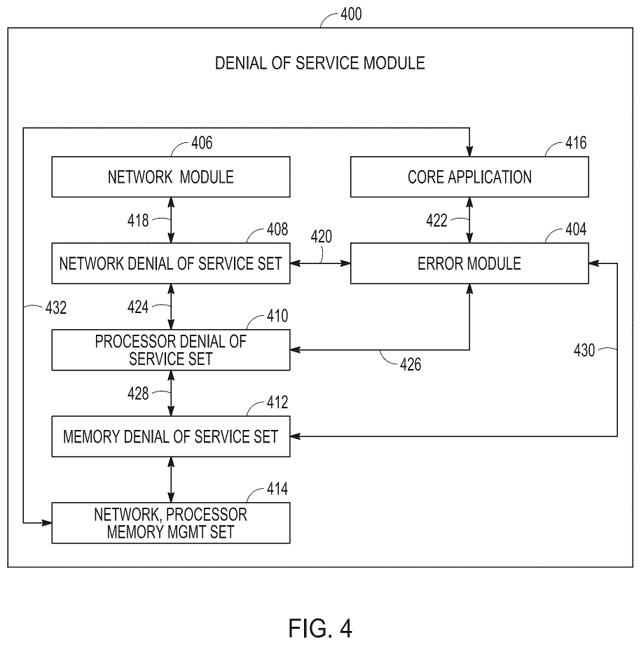

FIG. 4 illustrates a Denial of Service Module architecture. The Denial of Service Module architecture aligns with IEC 62443-3-3 and IEC 62443-4-2. Functional Requirement 7.1 for timely response to events. Resources experiencing Denial of Service conditions are detected and logged, and the application is placed into a Return to Safe State Set 402 within an Error Module 404.

The Denial of Service Module architecture 400 comprises a Network Module 406, a Network Denial of Service Set 408, a Processor Denial of Service Set 410, a Memory Denial of Service Set 412, a Network Processor Memory Management Set 414, the Error Module 404, and a Core Application 416. The Network Module 406 manages incoming and outgoing packets that communicate with the Core Application 416. The Network Denial of Service Set 408 detects when network traffic to the Core Application 416 is overflowing with data. Overflow network traffic is discarded to prevent a network DoS (Denial of Service). The Processor Denial of Service Set 410 detects when the processor has reached maximum throughput. The Memory Denial of Service Set 412 detects when processor memory is exhausted. The Network Processor Memory Management Set 414 manages successful normal cybersecurity functions when no Denial of Service conditions are detected. The Error Module 404 handles Denial of Service conditions and other errors. The Core Application 416 executes standard device functions without addressing cybersecurity functions.

The Denial of Service Module architecture 400 operates according to the following execution flows. Flow 418 routes traffic from the Network Module 406 to the Network Denial of Service Set 408 for traffic on authenticated and authorized sessions. Flow 420 routes execution from the Network Denial of Service Set 408 to the Error Module 404 when a Network Denial of Service error occurs. Flow 422 routes execution from the Core Application 416 to the Error Module 404 when an error occurs. Flow 424 routes execution from the Network Denial of Service Set 408 to the Processor Denial of Service Set 410 when no Network Denial of Service has occurred. Flow 426 routes execution from the Processor Denial of Service Set 410 to the Error Module 404 when a Processor Denial of Service occurs. Flow 428 routes execution from the Processor Denial of Service Set 410 to the Memory Denial of Service Set 412 when no Processor Denial of Service has occurred. Flow 430 routes execution from the Memory Denial of Service Set 412 to the Error Module 404 when a Memory Denial of Service occurs. Flow 432 routes execution from the Memory Denial of Service Set 412 to the Core Application 416 via the network, processor memory management set 414 when no Denial of Service conditions

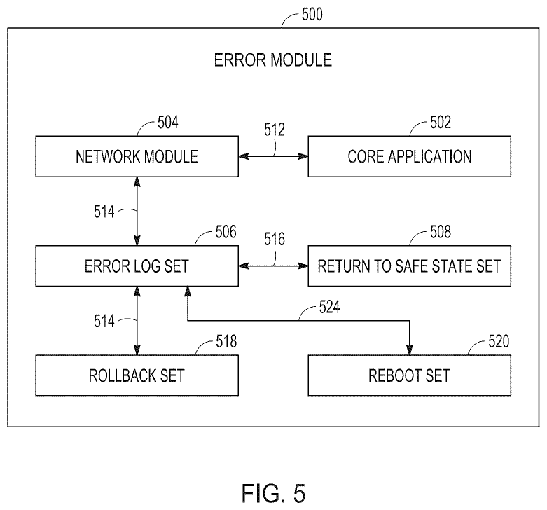

FIG. 5 illustrates an Error Module architecture 500. The Error Module architecture 500 is executed when errors occur within modules or sets of the cybersecurity shell and within a Core Application 502. The Error Module architecture 500 aligns with IEC 62443-3-3 requirements for timely response to events.

The Error Module architecture comprises a Network Module 504, an Error Log Set 506, a Return to Safe State Set 508, a Reboot Set 516, a Rollback Set 518, and the Core Application 502. The Network Module 504 manages incoming and outgoing packets that communicate with the Core Application 502. The Error Log Set 506 collects logging information from all the Cover shell modules and the Core application 502 stores them in an error log within the TPM or HSM. The Return to Safe State Set 508 returns the Core Application 502 to a safe state wherein the Core Application 502 is not in a risky fault condition. The Rollback Set 518 and the Reboot Set 520 also put the application into a safe state. The Core Application 502 receives traffic directly from an authorized session (Session Set 120) which is routed to the application for operations not related to cybersecurity.

The Error Module architecture operates according to the following execution flows. Flow 512 routes incoming and outgoing communication traffic to and from the Network Module 504 to the Core Application 502 when the session is already authenticated and the shell does not have any errors logged in a log in the TPM. through the Network Module 504 to an outside internet application. Flow 512 routes traffic from the Network Module 504 to the Core Application 502 when no negative conditions are detected. Flow 514 captures error information in the Error Log Set 506 when a Cover shell and Core application error occurs, and routes Error Log information through the Network Module 504 to a parent internet application. Flow 516 executes the Return to Safe State Set 508 when specific errors are logged in the Error Log Set 506. Flow 522 routes execution to/from the Error Log Set 506 to the Rollback Set 518 when sp errors are discovered. Flow 524 routes execution to/from the Error Log Set 506 to the Reboot Set 520 when an error occurs in the Core Application 502 or Cover shell.

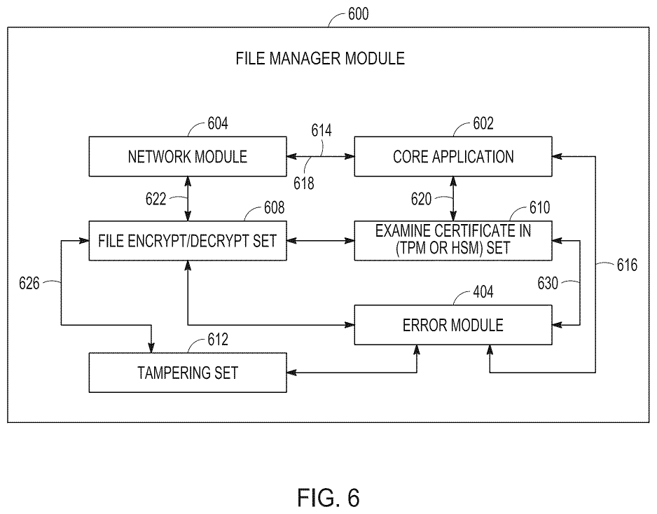

FIG. 6 illustrates a File Manager Module architecture. The File Manager Module architecture is executed when handling certificates or other files associated with cybersecurity and a Core Application 602.

The File Manager Module architecture comprises a Network Module 604, an Error Module 606, an Encrypt/Decrypt File Set 608, an Examine Certificate Set 610, a Tampering Set 612, and the Core Application 602. The Network Module 604 manages incoming and outgoing packets that communicate with the Core Application 602. The Error Module 606 handles errors that occur in the Core Application 602 or the cybersecurity shell. The Encrypt/Decrypt File Set 608 protects files at rest using encryption. The Examine Certificate Set 610 examines certificates stored in a TPM or HSM to determine if a secure boot is successful and addresses other file operations requiring file or stored data secrecy. The Tampering Set 612 detects tampering with files and data. The Core Application 602 receives traffic directly from a parent internet application for operations not related to cybersecurity.

The File Manager Module architecture operates according to the following execution flows. Flow 614 routes incoming communication traffic from a network or outgoing traffic from the Core Application 602 through the Network Module 604. Flow 616 routes execution to the Error Module 606 when negative conditions are detected in traffic. Flow 618 routes traffic from the Network Module 604 to the Core Application 602 when no negative conditions are detected. Flow 620 routes execution to the Error Module 606 when certificates stored in the TPM or HSM lead to file analysis failure. Flow 622 encrypts or decrypts data stored as files via the Encrypt Decrypt File Set 608. Flow 624 routes execution to the Error Module 606 when encryption or decryption fails. Flow 626 examines files via the Tampering Set 612. Flow 628 routes execution to the Error Module 606 for logging when tampering is detected. Flow 630 addresses errors from cybersecurity shell modules, sets, and the Core Application 602 within the Error Module 606.

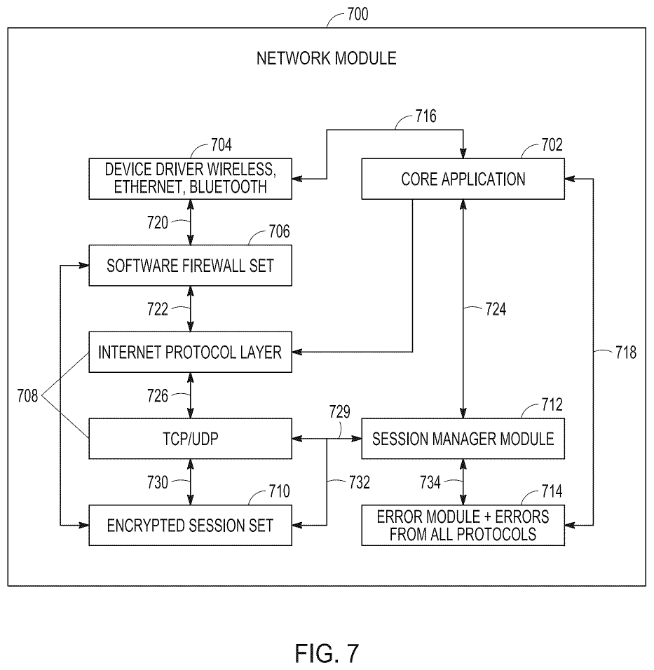

FIG. 7 illustrates a Network Module architecture. The Network Module architecture defines standards related to networking and protocols used to route traffic from the Network Module to a Core Application 702 and back to an application on an external network. The Network Module architecture 700 supports Bluetooth (IEEE 802.15.1), wireless standards (IEEE 802.11), Ethernet (IEEE 802.3), IP (RFC 791), TCP (RFC 9293), and https session protocols (RFC 2818).

The Network Module architecture comprises a Device Driver Set 704, a Software Firewall Set 706, an IP and TCP Layer Set 708, an Encrypted Session Set 710, a Session Manager Module 712, an Error Module 714, and the Core Application 702. The Device Driver Set 704 comprises functions and kernel software that receive incoming and outgoing network traffic via wireless, Bluetooth, and Ethernet device drivers, forwarding traffic up or down a TCP/IP network layer. The Software Firewall Set 706 analyzes incoming traffic to determine if data is properly formed or flooded at data link or session level layers. When the device or network layers are flooded with traffic such as a Denial of Service attack, the flooding traffic will be discarded and not forwarded upstream. The IP and TCP Layer Set 708 sends and receives traffic to and from a management application executing remotely on the external network. The Encrypted Session Set 710 sends and receives traffic from the TCP layer to TLS 1.2 or TLS 1.3 functions, ensuring all incoming and outgoing traffic is properly encrypted. The Session Manager Module 712 addresses session establishment and breakdown for authenticated users. The Error Module 714 handles errors that occur within the Network Module architecture 700, receiving execution from all modules and sets upon error. The Core Application 702 receives traffic directly from a parent application for operations not related to cybersecurity.

The Network Module architecture operates according to the following execution flows. Flow 716 routes network traffic from wireless, Bluetooth, or Ethernet networks to the Device Driver Set 704. Flow 718 routes execution to the Error Module 714 when device driver traffic has an error. Flow 720 routes Device Driver Set 704 traffic to and from the Software Firewall Set 706. Flow 722 routes IP layer traffic from the Software Firewall Set 706 to the IP and TCP Layer Set 708. Flow 724 routes traffic from the Session Manager Module 712 to the Core Application 702 and back. Flow 726 routes TCP or UDP layer traffic from the IP and TCP Layer Set 708. Flow 728 routes TCP or UDP traffic to the Session Manager Module 712, which forwards healthy session data to the Core Application 702. Flow 730 forwards TCP/IP traffic to the Encrypted Session Set 710. Flow 732 sends session data from the Encrypted Session Set 710 to the Session Manager Module 712 to start, stop, or maintain sessions. Flow 734 routes execution to the Error Module 714 when an error occurs in the Session Manager Module 712. Flow 736 forwards network set and Core Application 702 errors to the Error Module 714. Flow 738 routes traffic from the TCP/IP network layer to the Encrypted Session Set 710 as part of the Software Firewall Set 706.

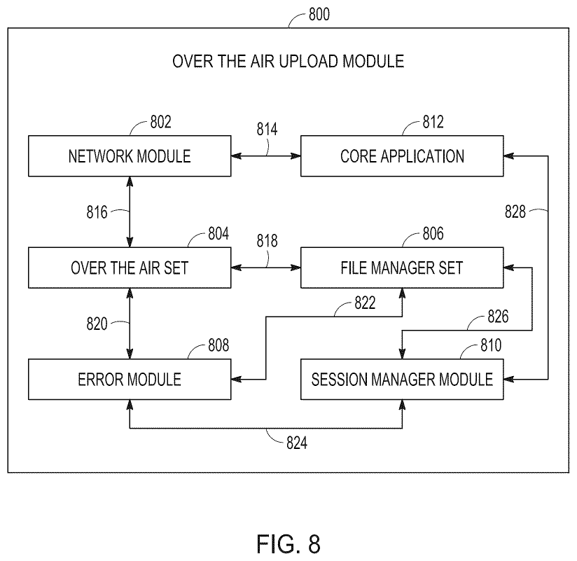

FIG. 8 illustrates an Over the Air Update Module architecture. The Over the Air Update Module architecture downloads cybersecurity configurations into the TPM or HSM hardware for execution by the shell. The Over the Air Update Module may also include embedded software updates. The success of an upload is determined via use of certificates stored in the TPM or HSM.

The Over the Air Update Module architecture comprises a Network Module 802, an Over the Air Set 804, a File Manager Set 806, an Error Module 808, a Session Manager Module 810, and a Core Application 812. The Network Module 802 manages incoming and outgoing packets that communicate with the Core Application 812. The Over the Air Set 804 uploads applications over the air. The File Manager Set 806 authenticates Over the Air uploads via certificates in a TPM or HSM. The Error Module 808 handles errors that occur within the Over the Air Set 804, the File Manager Set 806, and the Session Manager Module 810. The Session Manager Module 810 executes after the File Manager Set 806 succeeds, establishing a session between an external application and the Core Application 812. The Core Application 812 receives traffic to and from the Network Module 802.

The Over the Air Update Module architecture operates according to the following execution flows. Flow 814 routes traffic through the Network Module 802 via the Over the Air Set 804. Flow 816 downloads software to be executed via the Over the Air Set 804 through the Network Module 802. Flow 818 collects certificate information from the File Manager Set 806 to verify the upload is legitimate. Flow 820 routes execution to the Error Module 808 when the Over the Air Set 804 fails. Flow 822 routes execution to the Error Module 808 when the File Manager Set 806 using the certificate fails. Flow 824 executes the Session Manager Module 810 to set up a session with the Core Application 812 when the File Manager Set 806 succeeds. Flow 826 routes execution to the Error Module 808 when the Session Manager Module 810 fails. Flow 828 routes ongoing traffic directly to and from the Core Application 812 when the Session Manager Module 810 succeeds, bypassing session-related shell modules and sets.

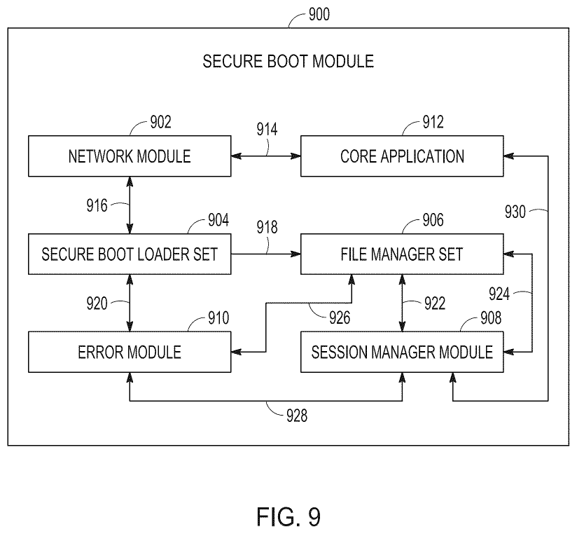

FIG. 9 illustrates a Secure Boot Module architecture 900. The Secure Bootloader Module architecture 900 aligns with NIST SP 800-193 requirements for platform firmware resiliency. The Secure Bootloader Module architecture loads the cybersecurity software and main embedded software into a System on Chip (SoC) chipset for execution, determining that a boot is successful using certificates stored in hardware such as Trusted Platform Modules (TPMs).

The Secure Bootloader Module architecture 900 comprises a Network Module 902, a Secure Bootloader Set 904, a File Manager Set 906, a Session Manager Module 908, an Error Module 910, and a Core Application 912. The Network Module 902 manages incoming and outgoing packets that communicate with the Core Application 912 via an external network or local wireless protocols. The Secure Bootloader Set 904 boots applications and downloads cybersecurity software. The File Manager Set 906 authenticates secure boot of downloaded applications via certificates in a TPM or HSM. The Session Manager Module 908 encrypts and decrypts session traffic. The Error Module 910 executes when errors occur during download. The Core Application 912 receives traffic directly from a parent application on an external network for operations not related to cybersecurity.

The Secure Bootloader Module architecture 900 operates according to the following execution flows. Flow 914 routes traffic through the Network Module 902 via the Core Application 912 running on an external network or via local wireless protocols. Flow 916 downloads software to be executed via the Secure Bootloader Set 904 through the Network Module 902. Flow 918 collects certificate information from the File Manager Set 906 to verify the download is legitimate. Flow 920 routes execution to the Error Module 910 when the File Manager Set 906 fails to authenticate with the certificate properly. Flow 922 executes the Session Manager Module 908 when the File Manager Set 906 using the certificate succeeds. Flow 924 forwards traffic to and from the Core Application 912 when the Session Manager Module 908 succeeds. Flow 926 routes execution to the Error Module 910 when the File Manager Set 906 fails. Flow 928 routes execution to the Error Module 910 and discards incoming Network Module 902 traffic when the Session Manager Module 908 fails. Flow 930 forwards incoming traffic to and from the Core Application 912 when the Session Manager Module 908 succeeds.

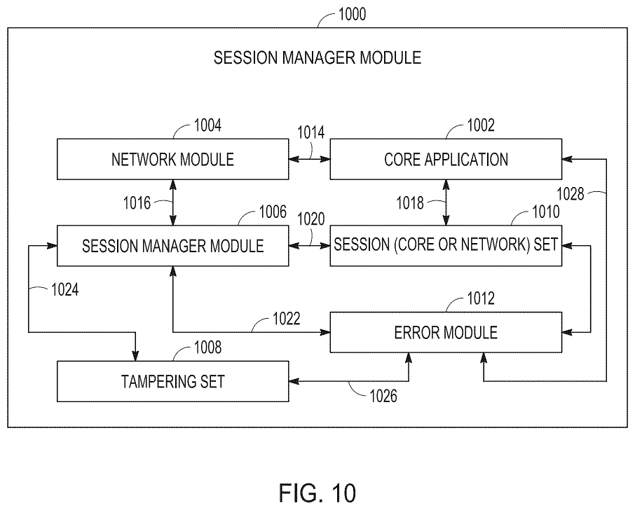

FIG. 10 illustrates a Session Manager Module architecture 1000. The Session Manager Module architecture 1000 manages sessions and encrypts and decrypts session traffic associated with cybersecurity and a Core Application 1002.

The Session Manager architecture comprises a Network Module 1004, a Tampering Set 1008, a Session Set 1010, an Error Module 1012, and the Core Application 1002. The Network Module 1004 manages incoming and outgoing packets that communicate with the Core Application 1002. The Session Manager Module 1006 handles sessions going to and from the Network Module 1004 or the Session Set 1010. The Tampering Set 1008 detects tampering with the System Module Sets. The Error Module 1012 handles errors from Cybersecurity Shell software and the Core Application 1002. The Core Application 1002 receives traffic directly from a parent application for operations not related to cybersecurity.

FIG. 10 shows the Session Manager Module architecture 1000 operates according to the following execution flows.

For the Session Manager Module interacts with the session to and from the Core Application 1002 and the shell itself. Flow 1018 establishes sessions between the Core Application 1002 and the Session Set 1010. Flow 1020 executes the Session Set 1010 from the Session Manager Module 1006 to set up sessions between the cybersecurity Core application and the Core Application 1002. Flow 1022 routes execution to the Error Module 1012 when an error occurs in the Session Manager Module 1006. Flow 1024 reviews sessions via the Tampering Set 1008 to determine if any session have been tampered with, returning execution to the Session Manager Module 1006 if no tampering is detected. Flow 1026 routes execution to the Error Module 1012 when the Tampering Set 1008 fails. Flow 1028 routes execution from the Core Application 1002 to the Error Module 1012 when an error occurs. The Core Application 1002 receives traffic directly from a parent application for operations not related to cybersecurity.

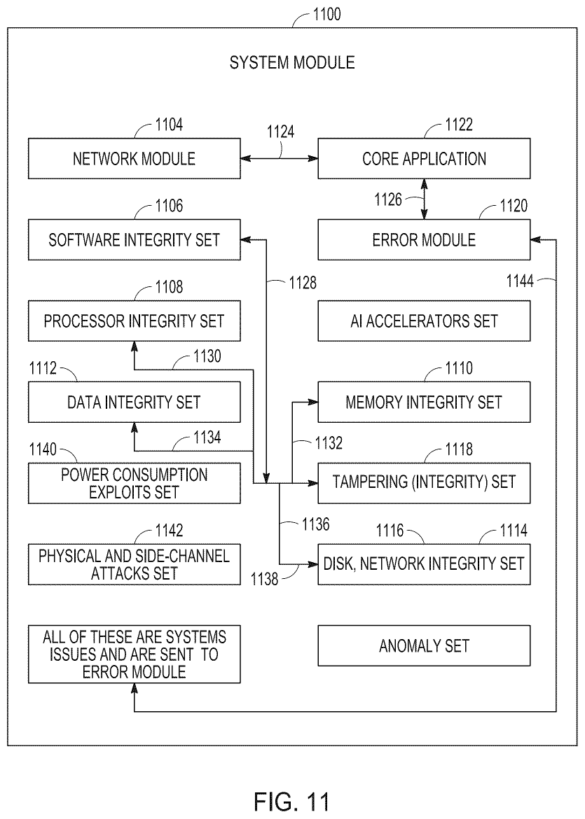

FIG. 11 illustrates a System/Hardware Module architecture. The System/Hardware Module architecture addresses system and hardware level integrity threats by detecting tampering with software, processor, memory, data, disk, and network components. All system and hardware errors are logged via the Error Module 1120, which places the application into a safe state.

The System/Hardware Module architecture comprises a Network Module 1104, a Software Integrity Set 1106, a Processor Integrity Set 1108, a Memory Integrity Set 1110, a Data Integrity Set 1112, a Disk Integrity Set 1114, a Network Integrity Set 1116, a Tampering Set 1118, an Error Module 1120, and a Core Application 1122. The Network Module 1104 manages incoming and outgoing network traffic to and from the Core Application 1122. The Software Integrity Set 1106 detects integrity violations in software components. The Processor Integrity Set 1108 detects integrity violations in processor operations. The Memory Integrity Set 1110 detects integrity violations in memory contents. The Data Integrity Set 1112 detects integrity violations in data. The Disk Integrity Set 1114 detects integrity violations in disk storage. The Network Integrity Set 1116 detects integrity violations in network communications. The Tampering Set 1118 receives execution from the integrity sets when tampering is detected. The Error Module 1120 handles system-level security issues and routes the Core Application 1122 to a safe state. The Core Application 1122 executes device-specific functions.

The System/Hardware Module architecture operates according to the following execution flows. Flow 1124 routes traffic from the Network Module 1104 to the Core Application 1122 accessing the cybersecurity shell from an external network or via local wireless protocols. Flow 1126 routes error conditions from the Core Application 1122 to the Error Module 1120. Flow 1128 executes the Tampering Set 1118 when the Software Integrity Set 1106 detects a software integrity violation. Flow 1130 executes the Tampering Set 1118 when the Processor Integrity Set 1108 detects a processor integrity violation. Flow 1132 executes the Tampering Set 1118 when the Memory Integrity Set 1110 detects a memory integrity violation. Flow 1134 executes the Tampering Set 1118 when the Data Integrity Set 1112 detects a data integrity violation. Flow 1136 executes the Tampering Set 1118 when the Disk Integrity Set 1114 detects a disk integrity violation. Flow 1138 executes the Tampering Set 1118 when the Network Integrity Set 1116 detects a network integrity violation.

The System/Hardware Module comprises additional security sets configured to detect specific categories of system and hardware level threats. A Malware Set is configured to detect malicious software within the cybersecurity shell and the Core Application by scanning executable code, monitoring process behavior, and comparing code signatures against known malware signatures. The Malware Set may utilize signature-based detection, heuristic analysis, or behavioral analysis to identify malware that has infiltrated the device. Upon detection of malware, the Malware Set routes execution to the Tampering Set for logging and safe state handling. A Side-Channel Attacks Set is configured to detect attacks that exploit physical implementation characteristics of the IoT device, including timing attacks that analyze execution time variations to extract cryptographic keys, electromagnetic analysis attacks that monitor electromagnetic emissions during cryptographic operations, and cache-based attacks that exploit processor cache behavior. The Side-Channel Attacks Set monitors for anomalous patterns in execution timing, power consumption, and electromagnetic emissions that may indicate ongoing side-channel attacks. A Power Consumption Exploits Set is configured to detect attacks that exploit power consumption characteristics of the device, including differential power analysis (DPA) attacks that correlate power consumption measurements with cryptographic operations to extract secret keys. The Power Consumption Exploits Set may implement countermeasures including power consumption randomization and constant-time cryptographic implementations. An Anomaly Set is configured to detect anomalous system behavior that deviates from established baseline patterns, including unusual network traffic patterns, unexpected process execution, abnormal memory access patterns, and irregular timing behavior. The Anomaly Set utilizes statistical analysis and machine learning techniques to identify deviations from normal operation that may indicate security threats not detected by signature-based methods.

A power consumption exploits set 1140 may also be used to detect exploits. A physical and side-channel attacks set 1142 may also be used to detect attacks. Flow 1144 routes execution from the Tampering Set 1118 to the Error Module 1120 for logging and safe state handling of violations, detected exploits, and attacks.

The Cover shell architecture of FIG. 1 addresses the need for IoT device developers to design devices that communicate with product management tools via communication protocol stacks while maintaining robust security. The Cover shell provides data communication protocols and security components that can be shared by multiple Core applications. This architecture enables quicker code updates, builds, integrations, and deployments because security functions are isolated within the IoT shell rather than scattered throughout different applications. The modular cybersecurity architecture of FIGS. 2-12 extends this concept by defining ten discrete security modules—Authentication and Authorization, Bridge, Denial of Service, Error, File Manager, Network, Over the Air Update, Secure Bootloader, Session Manager, and System/Hardware—each comprising sets of security functions organized in a hierarchical structure.

The modular architecture aligns with the IEC 62443 and STRIDE cybersecurity frameworks, mapping hardware and software functionalities to specific security requirements. This alignment with the STRIDE framework addresses the following threat categories: Spoofing, Tampering, Repudiation, Information Disclosure, Denial of Service, and Elevation of Privilege. The modular design localizes current and future cybersecurity changes, reduces product risk when new cybersecurity software is added or removed, and provides a consistent architecture that can be applied across multiple device types within an organization.

A detailed table illustrates these mappings, highlighting the role of a cybersecurity shell in ensuring compliance and resilience. This approach enhances device security while simplifying lifecycle management. It applies to all devices that use a TCP/IP or some wireless network interfaces. There are multiple modules that address different types of attacks. The cybersecurity frameworks that were used to formulate the modules are the following:
IEC 62443-3-3, 62443-4-2
STRIDE
NIST SP 800-193
NIST SP 800-218
RFCs (standards)

The IEC and STRIDE frameworks have IoT applications that are listed below. This IoT software runs on hardened operating systems or embedded operating systems.

The sections below show global IoT Applications.

### IoT Applications

Smart Home Devices—speakers, lighting systems, thermostats, appliances
Wearable Technology—smart watches, fitness trackers, health monitors
Automotive—connected cars, GPS trackers
Industrial IoT—predictive maintenance, asset tracking, remote monitoring and control, smart meters, robots
Healthcare—remote patient monitoring, smart medical devices, hospital asset tracking, medication adherence devices
Smart City Infrastructure—smart streetlights, environmental sensors, smart waste management, intelligent traffic management systems

The cybersecurity shell addresses the STRIDE Information Disclosure threat category which can also be named an Authorization Set. Tampering logic exists to prevent exposure of information to unauthorized individuals. The Authentication and Authorization Module comprises access control functions that restrict file access and data access to authorized users based on role-based access control policies, encryption functions that protect data at rest and data in transit from unauthorized reading, and data flow monitoring functions that detect and prevent unauthorized data exfiltration. When the Authorization Set detects an unauthorized access attempt, execution is routed to the Error Module for logging and the access attempt is denied.

### Relevant Modules and Sets

The module-based architecture maps the framework items listed above into framework modules and sets. This table shows that there are overlapping items between the two frameworks. See Table 3 above. Each of these framework categories can be modeled by a Module that becomes part of the cybersecurity architecture. The cybersecurity Modules are made up of Sets. Modules and Sets are combined together to become the cybersecurity architecture or shell.

Each module has sets that are groups of software functions. So, the hierarchy is module—sets—functions. The functions are the actual code that makes up a set. Those functions interact with the minimum portion of the Core Application as possible, so future changes are localized and not spread out through all of the embedded software.

A Cover shell or Core application that has discovered a security weakness may trigger an application rollback or application reboot if the application has been compromised.

The Cover shell covers or protects current IoT products by acting as a security blanket—Cover shell for Core applications. The Cover shell centralizes all common network, and security shell functions. AI support is optional and should only be used when results of the functions are discrete.

The modular cybersecurity architecture organizes security functions in a three-level hierarchy comprising modules, sets, and functions. At the highest level, modules represent discrete security domains that address specific categories of security requirements, such as authentication, denial of service detection, or error handling. Each module comprises one or more sets, where each set represents a group of related security functions that operate together to address a specific security concern within the module's domain. For example, the Authentication and Authorization Module comprise an Authentication Set, an Authorization Set, a Spoofing Set, an Elevation of Privilege Set, and a Non-Repudiation Set. At the lowest level, functions represent the actual executable code that implements the security logic within each set. The functions within each set are designed to interact with the minimum portion of the Core Application necessary to perform their security function, thereby localizing security-related code and minimizing the coupling between the cybersecurity shell and the Core Application. This hierarchical organization enables developers to update individual functions within a set, replace entire sets within a module, or add new modules to the cybersecurity shell without requiring modifications to the Core Application or to unrelated security modules. The localized nature of changes within the hierarchy reduces the risk of introducing new vulnerabilities when updating security functionality and simplifies testing and validation of security updates.

### Cover Shell Benefits

The Cover shell greatly aids developers so that they don't spend significant time adapting IoT devices to accommodate different communication and security APIs. They can share common communication, security modules and their supporting operating system APIs within the Cover shell. The Cover shell modules and sets can be updated more rapidly, protecting applications from global attacks more quickly, thereby lowering corporate risk.

For example: Medical device applications can use the same shell (Cover shell) as shown in FIG. 1 with HVAC applications. Both illustrate a communication protocol block and security function blocks with numbered flows between them.

A Trusted Platform Module defines Cover shell configurations to allow for easy device driver integration with Core applications. It centralizes Modules and Set functions so they can be made fully and deployed quickly.

This can be done quickly if the Core application has been integrated with updated APIs properly. A lack of proper API alignment with relevant Sets will limit the effectiveness of the architecture because some code may still be exposed to known threats if not all the needed functions were properly updated.

The Cover shell can manage an Authentication and Authorization Module, a Bridge Module, a Denial of Service Module, a File Manager Module, a Network Module, an Over the Air Update Module, a Secure Boot Module, Session Manager Module and a Systems/Hardware Manager. These Cover IoT functions can be shared by multiple types of Core applications. The Bridge Manager is optional. It is used only when there is a need to support an internal network. The Systems/Hardware Module has an AI Set that is optional.

Each Cover IoT shell can be integrated into different IoT Core IoT applications because it is an architecture and not software itself. The shell is adaptable to many different types of IoT devices.

### Different Software Flows and Applications

The Cover shell covers or protects current IoT products by acting as a security blanket or shell for Core applications. The Cover shell centralizes all network and security functions within it.

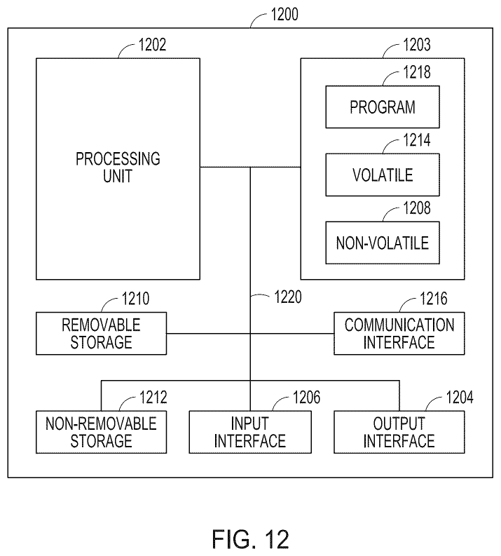

FIG. 12 is a block schematic diagram of a computer system 1200 to implement IoT devices and shell components and for performing methods and algorithms according to example embodiments. All components need not be used in various embodiments.

One example computing device in the form of a computer 1200 may include a processing unit 1202, memory 1204, removable storage 1206, and non-removable storage 1208. Although the example computing device is illustrated and described as computer 1200, the computing device may be in different forms in different embodiments. For example, the computing device may instead be a smartphone, a tablet, smartwatch, smart storage device (SSD), or other computing device including the same or similar elements as illustrated and described with regard to FIG. 12. Devices, such as smartphones, tablets, and smartwatches, are generally collectively referred to as mobile devices or user equipment.

Although the various data storage elements are illustrated as part of the computer 1200, the storage may also or alternatively include cloud-based storage accessible via a network, such as the Internet or server-based storage. Note also that an SSD may include a processor on which a parser may be run, allowing transfer of parsed, filtered data through I/O channels between the SSD and main memory.

Memory 1204 may include volatile memory 1210 and non-volatile memory 1212. Computer 1200 may include or have access to a computing environment that includes a variety of computer-readable media, such as volatile memory 1210 and non-volatile memory 1212, removable storage 1206 and non-removable storage 1208. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1200 may include or have access to a computing environment that includes input interface 1214, output interface 1216, and a communication interface 1218. Output interface 1216 may include a display device, such as a touchscreen, that also may serve as an input device. The input interface 1214 may include one or more of a touchscreen, touchpad, mouse, keyboard, camera, one or more device-specific buttons, one or more sensors integrated within or coupled via wired or wireless data connections to the computer 1200, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1200 are connected with a system bus 1220.

Computer-readable instructions stored on a computer-readable medium are executable by the processing unit 1202 of the computer 1200, such as a program 1222. The program 1222 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1222 may be used to cause processing unit 1202 to perform one or more methods or algorithms described herein.

### Examples

1. A communication and security Cover Shell for an Internet of Things (IoT) device, the Cover Shell including a device driver layer configured to collect network data from physical media using a communication protocol, wherein the communication protocol comprises at least one of Ethernet, wireless, or Bluetooth, a protocol stack comprising the device driver layer and a transmission control protocol/internet protocol (TCP/IP) layer over the device driver layer, a boot loader configured to receive an application image and load the application image into a device memory for execution, wherein the application image comprises a compilation of the Cover Shell and a Core Application, a file manager configured to manage certificates, session data, and configuration information, and to manage access to encryption data, configuration data at rest, and data in transit, wherein the file manager stores the certificates, the session data, and the configuration information in a trusted platform module (TPM) or a hardware security module (HSM), and a session manager configured to establish sessions that communicate with the Cover Shell, wherein the Core Application executes after an initial session established by the session manager is authenticated.

2. The communication and security Cover Shell of example 1, further including a plurality of security modules configured to protect the Core application, wherein the plurality of security modules are separate from the Core application and are configured to execute according to predefined execution flows between the security modules, wherein the predefined execution flows define communication paths such that unauthenticated network traffic is routed to an authentication set before being routed to the Core application.

3. The communication and security Cover Shell of any of examples 1-2, further including an internal denial of service manager configured to detect denial of service conditions, the internal denial of service manager comprising a network denial of service set configured to detect network traffic overflow, a processor denial of service set configured to detect processor resource exhaustion, and a memory denial of service set configured to detect memory resource exhaustion, wherein the internal denial of service manager is configured to sequentially evaluate network denial of service conditions, processor denial of service conditions, and memory denial of service conditions before routing traffic to the Core application.

4. The communication and security Cover Shell of any of examples 1-3, further including an error module comprising an error log set configured to collect logging information from the Cover Shell and the Core application, and a return to safe state set configured to return the Core application to a safe operating state upon detection of an error condition, wherein the file manager, the secure boot loader, and a software bridge application are each configured to route execution to the error module upon detection of an error condition.

5. The communication and security Cover Shell of any of examples 1-4, further including a data protection manager configured to encrypt data at rest associated with the Core application using a security algorithm defined in configuration data stored within the TPM or HSM hardware, wherein the file manager is used to protect session encryption data used by the session manager and certificate data used by the file manager.

6. The communication and security Cover Shell of any of examples 1-5, and further including a bridge module configured to support bridging traffic from external networks to internal networks, store the configuration data in the TPM or HSM.

7. The communication and security Cover Shell of example 6, wherein the TCP/IP layer is configured to coordinate traffic routing between the bridge module and the device driver layer.

8. The communication and security Cover Shell of any of examples 1-7, wherein the secure boot loader is configured to verify cryptographic signatures of downloaded software during startup, authenticate the downloaded software via certificates stored in a trusted platform module or a hardware security module accessed through the certificate manager, and upon successful authentication, route execution to a session manager module configured to establish sessions between external applications and the Core application.

9. The communication and security Cover Shell of any of examples 1-8, wherein the secure boot loader is configured to wirelessly receive the application image from an internet-based application.

10. The communication and security Cover Shell of any of examples 1-9, wherein the TPM or HSM are configured to manage cryptographic keys and performs cryptographic operations in a tamper-resistant manner.

11. A cybersecurity shell for protecting an Internet of Things (IoT) device, the cybersecurity shell including a core application configured to execute device-specific functions, a plurality of security modules configured to protect the core application, wherein the plurality of security modules are separate from the core application, a network module configured to manage network traffic between an external network and the core application, and a session manager module configured to establish sessions between authenticated entities and the core application, wherein the plurality of security modules is configured to execute according to predefined execution flows between the security modules, and wherein the cybersecurity shell localizes security functions to facilitate updates to the security modules without modification to the core application.

12. The cybersecurity shell of example 11, wherein the plurality of security modules further includes an authentication and authorization module comprising an authentication set configured to authenticate users and devices and an authorization set configured to determine access permissions for authenticated users and devices, wherein predefined execution flows route unauthenticated network traffic from the network module to the authentication set, route authenticated traffic from the authentication set to the authorization set, and route authorized traffic from the authorization set to the session manager module.

13. The cybersecurity shell of example 12, wherein the authentication and authorization module further includes a spoofing set configured to detect unauthorized access attempts using another entity's authentication information, an elevation of privilege set configured to detect unprivileged users attempting to gain privileged access, and a non-repudiation set configured to verify user actions using certificate-based verification, wherein the predefined execution flows route execution from the authentication set to the spoofing set and the elevation of privilege set during authentication.

14. The cybersecurity shell of any of examples 12-13, wherein the plurality of security modules further includes an error module comprising an error log set configured to collect logging information from the plurality of security modules and the core application, and a return to safe state set configured to return the core application to a safe operating state upon detection of an error condition, wherein the predefined execution flows route execution from each security module of the plurality of security modules to the error module upon detection of an error condition.

15. The cybersecurity shell of any of examples 12-14, wherein the plurality of security modules further includes a denial of service module comprising a network denial of service set configured to detect network traffic overflow, a processor denial of service set configured to detect processor resource exhaustion, and a memory denial of service set configured to detect memory resource exhaustion, wherein the predefined execution flows sequentially route network traffic through the network denial of service set, the processor denial of service set, and the memory denial of service set before routing traffic to the core application.

16. The cybersecurity shell of any of examples 12-15, wherein the plurality of security modules further includes a system module comprising a software integrity set configured to detect tampering with software components, a memory integrity set configured to detect tampering with memory contents, a data integrity set configured to detect tampering with data, and a tampering set configured to receive execution from the software integrity set, the memory integrity set, and the data integrity set upon detection of tampering, wherein the predefined execution flows route execution from the tampering set to an error module for logging and safe state handling.

17. The cybersecurity shell of any of examples 12-16, wherein the plurality of security modules further includes a bridge module configured to route traffic between the core application and an internal network using an internal network protocol distinct from an external network protocol used by the network module, the bridge module comprising a file manager set that reads configuration data within TPM or HSM hardware which defines a mapping to internal network devices, wherein the predefined execution flows route application data from the core application through the bridge module to the internal network devices.

18. The cybersecurity shell of any of examples 12-17, wherein the plurality of security modules further includes a secure bootloader module comprising a secure bootloader set configured to verify cryptographic signatures during startup and a file manager set configured to authenticate downloaded software via certificates stored in a trusted platform module or a hardware security module, wherein the predefined execution flows route execution from the secure bootloader set to the file manager set during startup, and route execution to the session manager module upon successful authentication.

19. The cybersecurity shell of any of examples 12-18, wherein the plurality of security modules further includes an over the air update module comprising an over the air set configured to receive software updates transmitted over the external network and a file manager set configured to authenticate the software updates via certificates, wherein the predefined execution flows route execution to an error module upon authentication failure and route execution to the session manager module upon authentication success.

20. The cybersecurity shell of any of examples 12-19, wherein the plurality of security modules are configured to satisfy IEC 62443 security requirements including identification and authentication controls in accordance with IEC 62443-3-3 and IEC 62443-4-2 Functional Requirement 1, use controls in accordance with IEC 62443-4-2 CR 2.1, data integrity requirements in accordance with IEC 62443-4-2 CR 3.1, data confidentiality requirements in accordance with IEC 62443-4-2 CR 4.1, and timely response to events requirements in accordance with IEC 62443-4-2 CR 7.1.

21. The cybersecurity shell of any of examples 12-29, wherein the session manager module further includes a session set configured to establish and manage sessions between the cybersecurity shell and the core application, and a tampering set configured to detect tampering with sessions managed by the session manager module, wherein the predefined execution flows bypass the authentication and authorization module and route session traffic directly to the core application for network traffic associated with an established session.

22. A method for securing an Internet of Things (IoT) device using a Cover Shell, the method including collecting network data from physical media at a device driver layer using a communication protocol comprising at least one of Ethernet, wireless, or Bluetooth, routing the network data through a protocol stack comprising the device driver layer and a transmission control protocol/internet protocol (TCP/IP) layer over the device driver layer, receiving an application image at a boot loader, wherein the application image comprises a compilation of the Cover Shell and a Core Application, and loading the application image into a device memory for execution, storing certificates, session data, and configuration information in a trusted platform module (TPM) or a hardware security module (HSM) via a file manager, establishing, by a session manager, an initial session that communicates with the Cover Shell, and authenticating the initial session before executing the Core Application.

### Further Examples

1. A communication and security shell for all Internet of Things (IoT) devices, the shell including a device driver layer selected to interface with a selected communication protocol, a set of communication layers. The communication layers include an IP network layer in communication over the device driver layer (wireless, Ethernet, or Bluetooth), a transport layer in communication over the IP network layer, and a session level application layer in communication with the transport layer. The secure boot loader loads the shell and a Core application into memory at startup. The TPM or HSM contain different configurations corresponding to different Core applications, each Core application is configured to execute within the shell. The application boot loader checks the certificate found in the TPM or HSM application and uses it to authenticate the downloaded software. The File Manager protects the shell data via use of the certificate.

2. The shell of wherein the Error Module forwards Error Log security conditions over the network to the internet application.

3. The shell of any of any of examples 1-2 wherein the File Manager includes an application data security algorithm.

Internet of Things (IoT) device Core application includes a device driver layer selected to interface with a set of communication layers for implementing a selected communication protocol, a secure boot loader that loads the shell and the core application into memory at startup of the IoT device, and the TPM or HSM that contains critical shell and Core Application data.

Each core application is configured to execute within the shell and core application. The core application executes directly above the TCP or https layers which execute over the device driver layers made up of wireless, Bluetooth, and Ethernet protocols.

5. The shell of example 4 and further including a data protection manager configured to protect Core application data.

6. The shell of example 5 and further including an Denial of Service manager configured to address denial of service (DoS) needs within the shell or Core application.

7. The shell of example 5, Error Module is used to analyze anomalies, and the error log. It returns the application to a safe state, reboot the application, or rollback the application.

8. The application image is formulated through the integrated Core application and Cover shell modules and corresponding sets. The parent application connects with an Internet of Things (IoT) application to a communication network via a communication and security shell. The IoT application image is made up of the integration of communication layers via a shell device driver and the Core Application. The loading of the image into memory is completed via the boot loader or the over the air update. The image is made up the integration of the modules and sets functions within the Cover shell and the original Core application.

The Core application protects the shell functions that are part of the module and set architecture. The integrated application handles Bluetooth, wireless, or Ethernet traffic that is forwarded up thru the transmission control protocol/internet protocol (TCP/IP) layer of the communication layers. Security traffic is forwarded thru the shell to the Core application or they are managed via shell functions that map to the shell architecture.

9. The method of example 8 includes addressing certificate needs for the secure boot loader and for the File Manager.

### Module-Based Architecture Examples

1. A cybersecurity shell for protecting an operational technology (IoT) device, the cybersecurity shell includes a Core Application configured to execute device-specific functions of the IoT device, a plurality of security modules configured to protect the Core Application, the plurality of security modules including: an Authentication and Authorization Module configured to authenticate users and devices and to authorize access to the Core Application; a Denial of Service Module configured to detect denial of service conditions affecting network resources, processor resources, and memory resources; an Error Module configured to log errors from the plurality of security modules and the Core Application and to return the IoT device to a safe state; a Network Module configured to manage incoming and outgoing network traffic using communication protocols; a Session Manager Module configured to establish and manage sessions between authenticated users and the Core Application; and a System/Hardware Module configured to detect malware and system integrity violations, wherein each security module of the plurality of security modules comprises one or more sets of security functions wherein the plurality of security modules are configured to execute according to predefined execution flows between the security modules.

2. The cybersecurity shell of example 1-1, wherein the plurality of security modules further comprises a Bridge Module configured to route traffic between the Core Application and an internal network using an internal network protocol distinct from an external network protocol.

3. The cybersecurity shell of any of examples 1-2, wherein the plurality of security modules further comprises a File Manager Module configured to manage certificates and configuration files used by the plurality of security modules and the Core Application.

4. The cybersecurity shell of any of examples 1-3, wherein the plurality of security modules further comprises a Secure Bootloader Module configured to verify cryptographic signatures during startup of the IoT device and to load the Core Application into memory.

5. The cybersecurity shell of any of examples 1-4, wherein the plurality of security modules further comprises an Over the Air Update Module configured to receive and authenticate software updates transmitted over a network.

6. The cybersecurity shell of any of examples 1-5, wherein each set of security functions within each security module comprises a plurality of functions, and wherein the plurality of functions interact with a minimum portion of the Core Application to localize future changes to the cybersecurity shell.

7. The cybersecurity shell of any of examples 1-6, wherein the predefined execution flows define communication paths between the plurality of security modules such that the Network Module routes unauthenticated traffic to the Authentication and Authorization Module, the Authentication and Authorization Module routes authenticated traffic to the Session Manager Module, and the Session Manager Module routes session traffic to the Core Application.

8. The cybersecurity shell of any of examples 1-7, wherein the Error Module is configured to receive error information from each security module of the plurality of security modules and from the Core Application.

9. The cybersecurity shell of any of examples 1-8, wherein the Denial of Service Module includes a Network Denial of Service Set configured to detect network traffic overflow, a Processor Denial of Service Set configured to detect processor throughput exhaustion, and a Memory Denial of Service Set configured to detect memory exhaustion.

10. The cybersecurity shell of any of examples 1-9, wherein the cybersecurity shell is configured to protect the Core Application without modification to device-specific functions of the Core Application.

### Framework Compliance Examples

1. A cybersecurity shell for an operational technology (IoT) device, the cybersecurity shell includes a Core Application configured to execute device-specific functions, a plurality of security modules configured to satisfy IEC 62443 security requirements, the plurality of security modules including: an Identification and Authentication Control component configured to verify firmware integrity and enforce user authentication in accordance with IEC 62443-3-3 Functional Requirement 1; a Use Control component configured to restrict device functions to authorized uses via isolated execution in accordance with IEC 62443-4-2 CR 2.1; a Data Integrity component configured to ensure data integrity using encryption in accordance with IEC 62443-4-2 CR 3.1; a Data Confidentiality component configured to protect sensitive data with secure storage in accordance with IEC 62443-4-2 CR 4.1; and a Timely Response to Events component configured to detect and log security events in real-time in accordance with IEC 62443-4-2 CR 7.1.

2. The cybersecurity shell of example 1-1, wherein the Cover shell includes a Secure Boot Loader Set configured to verify digital signatures during startup security via the Sets in the File Manager Module and Session Manager Module.

3. The cybersecurity shell of any of examples 1-2, wherein the Use Control component comprises a Trusted Execution Environment configured to provide an isolated environment for sensitive operations.

4. The cybersecurity shell of any of examples 1-3, wherein the Data Integrity component comprises a Cryptographic Accelerator configured to perform encryption and decryption using AES-256.

5. The cybersecurity shell of any of examples 1-4, wherein the Data Confidentiality component comprises a Tamper-Resistant Memory configured to store cryptographic keys and prevent unauthorized access.

6. The cybersecurity shell of any of examples 1-5, wherein the Timely Response to Events component includes an Intrusion Detection System configured to monitor system behavior and log anomalies, and a File Manager Module configured to manage cryptographic operations.

7. The cybersecurity shell of any of examples 1-6, wherein the plurality of security modules are further configured to satisfy IEC 62443-3-3 Functional Requirement 7.1 for system availability and resource availability.

8. The cybersecurity shell of any of examples 1-7, wherein the Identification and Authentication Control component is configured to verify firmware updates to prevent installation of malicious code.

9. The cybersecurity shell of any of examples 1-8, further comprising an Update Manager configured to manage secure incremental updates to the cybersecurity shell while minimizing changes to the Core Application.

10. The cybersecurity shell of any of examples 1-9, wherein the plurality of security modules are configured to align with IEC 62443-4-2 requirements for embedded device security.

### STRIDE-Specific Examples

1. A cybersecurity shell for an operational technology (IoT) device, the cybersecurity shell includes a Core Application configured to execute device-specific functions, a plurality of security components configured to address STRIDE threat categories, the plurality of security components including: a Spoofing Detection Set configured to detect unauthorized access using another user's authentication information, a Tampering Detection Set configured to detect malicious modification of data, a Non-Repudiation Set configured to verify user actions using certificate-based verification, an Information Disclosure Prevention Set configured to prevent exposure of information to unauthorized individuals, a Denial of Service Detection Set configured to detect attacks that deny service to valid users, and an Elevation of Privilege Detection Set configured to detect unprivileged users gaining privileged access.

2. The cybersecurity shell of example 1-1, wherein the Spoofing Detection Set is located within an Authentication and Authorization Module and is configured to detect illegitimate use of username and password information.

3. The cybersecurity shell of any of examples 1-2, wherein the Tampering Detection Set is located within a Session Manager Module and is configured to detect unauthorized changes to session data.

4. The cybersecurity shell of any of examples 1-3, wherein the Non-Repudiation Set is configured to use certificates stored in a TPM or HSM to verify user actions.

5. The cybersecurity shell of any of examples 1-4, wherein the Non-Repudiation Set is further configured to log user actions to prevent users from denying performed actions.

6. The cybersecurity shell of any of examples 1-5, wherein the Information Disclosure Prevention Set comprises an Access Control Module configured to restrict file access to authorized users.

7. The cybersecurity shell of any of examples 1-6, wherein the Denial of Service Module includes a Network Denial of Service Set configured to detect network traffic overflow, a Processor Denial of Service Set configured to detect processor resource exhaustion, and a Memory Denial of Service Set configured to detect memory resource exhaustion.

8. The cybersecurity shell of any of examples 1-7, wherein the Elevation of Privilege Detection Set is configured to execute when the Authentication and Authorization Module is in an execution flow.

9. The cybersecurity shell of any of examples 1-8, further comprising an Error Module configured to receive error information when the Spoofing Detection Set detects spoofing, when the Tampering Detection Set detects tampering, or when the Elevation of Privilege Detection Set detects privilege elevation.

10. The cybersecurity shell of any of examples 1-9, wherein the Tampering Detection Set is further configured to detect unauthorized changes to persistent data and to data in transit between computers.

### Method Examples with Execution Flows

1. A computer-implemented method for securing an IoT device using a cybersecurity shell, the method comprising receiving network traffic at a Network Module of the cybersecurity shell, determining whether the network traffic is associated with an established session, when the network traffic is not associated with an established session, routing the network traffic to an Authentication Set of an Authentication and Authorization Module, executing the Authentication Set to authenticate a user or device associated with the network traffic, upon authentication failure, executing an Error Module to log an authentication error, upon authentication success, routing the network traffic to an Authorization Set of the Authentication and Authorization Module, executing the Authorization Set to determine access permissions for the authenticated user or device upon authorization failure, executing the Error Module to log an authorization error, upon authorization success, executing a Session Manager Module to establish a session, and routing subsequent session traffic directly to a Core Application.

2. The method of example 1, further including executing an Elevation of Privilege Set when the Authentication Set is in an execution flow to detect unprivileged users gaining privileged access.

3. The method of any of examples 1-2, further including executing a Non-Repudiation Set to determine whether sessions associated with the Session Manager Module can be compromised.

4. The method of any of examples 1-3, further including executing a Spoofing Set from the Authentication Set to detect whether spoofing has occurred, and upon detection of spoofing, executing the Error Module to log a spoofing error.

5. The method of any of examples 1-4, further including when the network traffic is associated with an established session, bypassing the Authentication Set and routing the session traffic directly to the Core Application.

6. The method of any of examples 1-5, wherein executing the Error Module includes logging error information in an Error Log Set, and executing a Return to Safe State Set to return the Core Application to a safe operating state.

7. The method of any of examples 1-6, further including prior to receiving network traffic at the Network Module, executing a Secure Bootloader Module to verify cryptographic signatures and load the Core Application into memory.

8. The method of any of examples 1-7, further including routing the network traffic through a Denial of Service Module prior to routing to the Authentication and Authorization Module, executing a Network Denial of Service Set to detect network denial of service attacks executing a Processor Denial of Service Set to detect processor denial of service attacks, executing a Memory Denial of Service Set to detect memory denial of service attacks and upon detection of a denial of service attack, executing the Error Module.

9. The method of any of examples 1-8, wherein routing the network traffic to the Authentication Set includes receiving the network traffic at a Device Driver Set of the Network Module, routing the network traffic from the Device Driver Set to a Software Firewall Set, routing the network traffic from the Software Firewall Set to an IP Layer Set, routing the network traffic from the IP Layer Set to a TCP Layer Set, and routing the network traffic from the TCP and UDP Layer Set to an Session Set.

10. The method of any of examples 1-9, further including upon session manager failure, executing the Error Module to log a session error.

### System/Hardware Module Examples

1. An IoT device including a Core Application is configured to execute device-specific functions, a Network Module configured to manage incoming and outgoing network traffic, an Error Module configured to log errors and return the IoT device to a safe state, and a System/Hardware Module configured to detect system-level security threats, the System/Hardware Module including a Malware Set configured to detect malware within the cybersecurity shell and the Core Application, a Software Integrity Set configured to detect tampering with software components a Memory Integrity Set configured to detect tampering with memory contents, a Data Integrity and Confidentiality Set configured to detect tampering with data, a Side-Channel Attacks Set configured to detect side-channel attacks, and a Power Consumption Exploits Set configured to detect power consumption-based attacks.

2. The cybersecurity shell of example 1, wherein the System/Hardware Module further includes a Tampering Set configured to receive execution flow from the Software Integrity Set, the Memory Integrity Set, and the Data Integrity and Confidentiality Set when tampering is detected.

3. The cybersecurity shell of any of examples 1-2, wherein the System/Hardware Module further includes an Anomaly Set configured to detect anomalous system behavior.

4. The cybersecurity shell of any of examples 1-3, wherein the System/Hardware Module is configured to route system-level security issues to the Error Module for logging.

5. The cybersecurity shell of any of examples 1-4, wherein the Software Integrity Set is configured to execute the Tampering Set when software integrity violations are detected.

6. The cybersecurity shell of any of examples 1-5, wherein the Memory Integrity Set is configured to execute the Tampering Set when memory integrity violations are detected.

7. The cybersecurity shell of any of examples 1-6, wherein the Data Integrity and Confidentiality Set is configured to execute the Tampering Set when data integrity violations are detected.

8. The cybersecurity shell of any of examples 1-7, wherein the System/Hardware Module further includes a File Manager Module configured to manage certificates and configuration files, and a Session Manager Module configured to manage sessions between the cybersecurity shell and the Core Application.

9. The cybersecurity shell of any of examples 1-8, wherein the Side-Channel Attacks Set is configured to detect attacks that exploit physical implementation characteristics of the IoT device.

10. The cybersecurity shell of any of examples 1-9, wherein the System/Hardware Module is configured to detect system-level security threats using hardware-based detection and software-based detection.

### Bridge Module Examples

1. A cybersecurity shell for an operational technology (IoT) device, the cybersecurity shell including a Core Application configured to execute device-specific functions, a Network Module configured to manage incoming and outgoing network traffic using an external network protocol, an Error Module configured to log errors from the cybersecurity shell and the Core Application, and a Bridge Module configured to route traffic between the Core Application and an internal network, the Bridge Module including: a Session Manager Module configured to establish sessions between the Core Application and internal network modules. The Examine Certificate Set reads configuration data from the TPM or HSM.

2. The cybersecurity shell of example 1-1, wherein the internal network protocol such as Modbus.

3. The cybersecurity shell of any of examples 1-3, wherein the Bridge Module is configured to receive application data from the Core Application reads the configuration data from the File Manager Set to determine routing to internal network devices, and route the application data to the internal network devices using the internal network protocol.

4. The cybersecurity shell of any of examples 1-3, wherein the Bridge Module is configured to execute when application data is manipulated by the Core Application and transmitted to internal application components on the internal network.

5. The cybersecurity shell of any of examples 1-3, wherein the Session Manager Module of the Bridge Module is configured to upon session establishment success, route application data to the Core Application, and upon session establishment failure, execute the Error Module.

6. The cybersecurity shell of any of examples 1-5, wherein the File Manager Set is configured to upon successful reading of the configuration file, certificates, and algorithms. The shell routes execution flow to and from the Core Application, and upon failure are routed to the Error Module.

7. The cybersecurity shell of any of examples 1-6, wherein the Network Module receives traffic from the Core Application and routes the traffic to the Session Manager Module of the Bridge Module when the traffic is destined for the internal network.

8. The cybersecurity shell of any of examples 1-7, wherein the Bridge Module is present in the cybersecurity shell when application data is transmitted to internal application components that execute on the internal network.

9. The cybersecurity shell of any of examples 1-8, wherein the external network protocol includes TCP/IP and the internal network protocol comprises a fieldbus protocol.

10. A computer-implemented method for routing traffic in an operational technology (IoT) device using a cybersecurity shell, the method including receiving network traffic at a Network Module from an external network using an external network protocol, routing the network traffic to a Core Application, receiving application data from the Core Application destined for an internal network establishing a session via a Session Manager Module of a Bridge Module upon session establishment success, reading configuration data from a File Manager Set to determine routing to internal network devices, upon successful reading of the configuration data, routing the application data to the internal network devices using an internal network protocol distinct from the external network protocol, and upon session establishment failure or configuration reading failure, executing an Error Module.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A communication and security Cover Shell for an Internet of Things (IoT) device, the Cover Shell comprising:
a device driver layer configured to collect network data from physical media using a communication protocol, wherein the communication protocol comprises at least one of Ethernet, wireless, or Bluetooth;
a protocol stack comprising the device driver layer and a transmission control protocol/internet protocol (TCP/IP) layer over the device driver layer;
a boot loader configured to receive an application image and load the application image into a device memory for execution, wherein the application image comprises a compilation of the Cover Shell and a Core Application;
a file manager configured to manage certificates, session data, and configuration information, and to manage access to encryption data, configuration data at rest, and data in transit, wherein the file manager stores the certificates, the session data, and the configuration information in a trusted platform module (TPM) or a hardware security module (HSM); and
a session manager configured to establish sessions that communicate with the Cover Shell, wherein the Core Application executes after an initial session established by the session manager is authenticated.

2. The communication and security Cover Shell of claim 1, further comprising:
a plurality of security modules configured to protect the Core application, wherein the plurality of security modules are separate from the Core application and are configured to execute according to predefined execution flows between the security modules;
wherein the predefined execution flows define communication paths such that unauthenticated network traffic is routed to an authentication set before being routed to the Core application.

3. The communication and security Cover Shell of claim 1, further comprising:
an internal denial of service manager configured to detect denial of service conditions, the internal denial of service manager comprising a network denial of service set configured to detect network traffic overflow, a processor denial of service set configured to detect processor resource exhaustion, and a memory denial of service set configured to detect memory resource exhaustion;
wherein the internal denial of service manager is configured to sequentially evaluate network denial of service conditions, processor denial of service conditions, and memory denial of service conditions before routing traffic to the Core application.

4. The communication and security Cover Shell of claim 1, further comprising:
an error module comprising an error log set configured to collect logging information from the Cover Shell and the Core application, and a return to safe state set configured to return the Core application to a safe operating state upon detection of an error condition;
wherein the file manager, the secure boot loader, and a software bridge application are each configured to route execution to the error module upon detection of an error condition.

5. The communication and security Cover Shell of claim 1, further comprising:
a data protection manager configured to encrypt data at rest associated with the Core application using a security algorithm defined in configuration data stored within the TPM or HSM hardware;
wherein the file manager is used to protect session encryption data used by the session manager and certificate data used by the file manager.

6. The communication and security Cover Shell of claim 1, and further comprising a bridge module configured to:
support bridging traffic from external networks to internal networks; and
store the configuration data in the TPM or HSM.

7. The communication and security Cover Shell of claim 6, wherein the TCP/IP layer is configured to coordinate traffic routing between the bridge module and the device driver layer.

8. The communication and security Cover Shell of claim 1, wherein the secure boot loader is configured to:
verify cryptographic signatures of downloaded software during startup;
authenticate the downloaded software via certificates stored in a trusted platform module or a hardware security module accessed through the certificate manager; and
upon successful authentication, route execution to a session manager module configured to establish sessions between external applications and the Core application.

9. The communication and security Cover Shell of claim 1, wherein the secure boot loader is configured to wirelessly receive the application image from an internet-based application.

10. The communication and security Cover Shell of claim 1, wherein the TPM or HSM manage cryptographic keys and performs cryptographic operations in a tamper-resistant manner.

11. A cybersecurity shell for protecting an Internet of Things (IoT) device, the cybersecurity shell comprising:
a core application configured to execute device-specific functions;
a plurality of security modules configured to protect the core application, wherein the plurality of security modules are separate from the core application;
a network module configured to manage network traffic between an external network and the core application; and
a session manager module configured to establish sessions between authenticated entities and the core application;
wherein the plurality of security modules is configured to execute according to predefined execution flows between the security modules, and wherein the cybersecurity shell localizes security functions to facilitate updates to the security modules without modification to the core application.

12. The cybersecurity shell of claim 11, wherein the plurality of security modules further comprises:
an authentication and authorization module comprising an authentication set configured to authenticate users and devices and an authorization set configured to determine access permissions for authenticated users and devices;
wherein predefined execution flows route unauthenticated network traffic from the network module to the authentication set, route authenticated traffic from the authentication set to the authorization set, and route authorized traffic from the authorization set to the session manager module.

13. The cybersecurity shell of claim 12, wherein the authentication and authorization module further comprises:
a spoofing set configured to detect unauthorized access attempts using another entity's authentication information;
an elevation of privilege set configured to detect unprivileged users attempting to gain privileged access; and
a non-repudiation set configured to verify user actions using certificate-based verification, wherein the predefined execution flows route execution from the authentication set to the spoofing set and the elevation of privilege set during authentication.

14. The cybersecurity shell of claim 12, wherein the plurality of security modules further comprises:
an error module comprising an error log set configured to collect logging information from the plurality of security modules and the core application, and a return to safe state set configured to return the core application to a safe operating state upon detection of an error condition;
wherein the predefined execution flows route execution from each security module of the plurality of security modules to the error module upon detection of an error condition.

15. The cybersecurity shell of claim 12, wherein the plurality of security modules further comprises:
a denial of service module comprising a network denial of service set configured to detect network traffic overflow, a processor denial of service set configured to detect processor resource exhaustion, and a memory denial of service set configured to detect memory resource exhaustion;
wherein the predefined execution flows sequentially route network traffic through the network denial of service set, the processor denial of service set, and the memory denial of service set before routing traffic to the core application.

16. The cybersecurity shell of claim 12, wherein the plurality of security modules further comprises:
a system module comprising a software integrity set configured to detect tampering with software components, a memory integrity set configured to detect tampering with memory contents, a data integrity set configured to detect tampering with data, and a tampering set configured to receive execution from the software integrity set, the memory integrity set, and the data integrity set upon detection of tampering;
wherein the predefined execution flows route execution from the tampering set to an error module for logging and safe state handling.

17. The cybersecurity shell of claim 12, wherein the plurality of security modules further comprises:
a bridge module configured to route traffic between the core application and an internal network using an internal network protocol distinct from an external network protocol used by the network module, the bridge module comprising a file manager set that reads configuration data within TPM or HSM hardware which defines a mapping to internal network devices;
wherein the predefined execution flows route application data from the core application through the bridge module to the internal network devices.

18. The cybersecurity shell of claim 12, wherein the plurality of security modules further comprises:
a secure bootloader module comprising a secure bootloader set configured to verify cryptographic signatures during startup and a file manager set configured to authenticate downloaded software via certificates stored in a trusted platform module or a hardware security module;
wherein the predefined execution flows route execution from the secure bootloader set to the file manager set during startup, and route execution to the session manager module upon successful authentication.

19. The cybersecurity shell of claim 12, wherein the plurality of security modules further comprises:
an over the air update module comprising an over the air set configured to receive software updates transmitted over the external network and a file manager set configured to authenticate the software updates via certificates;
wherein the predefined execution flows route execution to an error module upon authentication failure and route execution to the session manager module upon authentication success.

20. The cybersecurity shell of claim 12, wherein the plurality of security modules are configured to satisfy IEC 62443 security requirements comprising:
identification and authentication controls in accordance with IEC 62443-3-3 and IEC 62443-4-2 Functional Requirement 1;
use controls in accordance with IEC 62443-4-2 CR 2.1;
data integrity requirements in accordance with IEC 62443-4-2 CR 3.1;
data confidentiality requirements in accordance with IEC 62443-4-2 CR 4.1; and
timely response to events requirements in accordance with IEC 62443-4-2 CR 7.1.

21. The cybersecurity shell of claim 12, wherein the session manager module further comprises:
a session set configured to establish and manage sessions between the cybersecurity shell and the core application; and
a tampering set configured to detect tampering with sessions managed by the session manager module;
wherein the predefined execution flows bypass the authentication and authorization module and route session traffic directly to the core application for network traffic associated with an established session.

22. A method for securing an Internet of Things (IoT) device using a Cover Shell, the method comprising:
collecting network data from physical media at a device driver layer using a communication protocol comprising at least one of Ethernet, wireless, or Bluetooth;
routing the network data through a protocol stack comprising the device driver layer and a transmission control protocol/internet protocol (TCP/IP) layer over the device driver layer;
receiving an application image at a boot loader, wherein the application image comprises a compilation of the Cover Shell and a Core Application, and loading the application image into a device memory for execution;
storing certificates, session data, and configuration information in a trusted platform module (TPM) or a hardware security module (HSM) via a file manager;
establishing, by a session manager, an initial session that communicates with the Cover Shell; and
authenticating the initial session before executing the Core Application.
